(19) United States
(12) Patent Application Publication
(10) Pub. No.: US 2021/0230056 A1
(43) Pub. Date: Jul. 29, 2021

(54) LOW-WARP, STRENGTHENED ARTICLES AND ASYMMETRIC ION-EXCHANGE METHODS OF MAKING THE SAME

(71) Applicant: CORNING INCORPORATED, CORNING, NY (US)

(72) Inventors: Brian Sterling Chan, Painted Post, NY (US); Yinghong Chen, Painted Post, NY (US); Sumalee Likitvanichkul Fagan, Painted Post, NY (US); Jun Hou, Painted Post, NY (US); Qiao Li, Horseheads, NY (US); Santona Pal, Painted Post, NY (US); Rohit Rai, Painted Post, NY (US)

(21) Appl. No.: 15/734,109

(22) PCT Filed: May 31, 2019
(86) PCT No.: PCT/US2019/034860

§ 371 Date: Dec. 1, 2020

Related U.S. Application Data
(60) Provisional application No. 62/747,762, filed on Oct. 19, 2018.
(60) Provisional application No. 62/679,324, filed on Jun. 1, 2018.

(51) Int. Cl. C03C 21/00; C03C 4/18; C03C 3/083; C03C 3/087; C03C 3/089; C03C 3/097

(52) U.S. Cl. CPC C03C 21/002; C03C 4/18; C03C 3/083; C03C 2204/00; C03C 3/089; C03C 3/097; C03C 3/087

(57) ABSTRACT

A method of making strengthened articles that includes: providing articles comprising ion-exchangeable alkali metal ions and first and second primary surfaces; providing a bath comprising ion-exchanging alkali metal ions larger in size than the ion-exchangeable ions; and submersing the articles in the bath at a first ion-exchange temperature and duration to form strengthened articles. Each strengthened article comprises a compressive stress region. Further, the exchange rate of the ion-exchanging alkali metal ions is higher into the first primary surface than into the second primary surface. In addition, the submersing step is conducted such that a predetermined gap is maintained between the first primary surface of each of the articles.

### CROSS-REFERENCE TO RELATED APPLICATIONS

This application claims the benefit of priority under 35 U.S.C. § 119 of U.S. Provisional Application Ser. No. 62/747,762 filed on Oct. 19, 2018 and U.S. Provisional Application Ser. No. 62/679,324 filed on Jun. 1, 2018, the content of which is relied upon and incorporated herein by reference in its entirety.

### FIELD OF THE DISCLOSURE

The present disclosure relates generally to low-warp, strengthened articles and methods of making these articles; and, more particularly, asymmetric ion-exchange methods of making strengthened glass, glass-ceramic and ceramic substrates employed in various articles.

### BACKGROUND

Protective display covers based on chemically strengthened, ion-exchanged glass substrates are employed in several industries, including consumer electronics (e.g., smartphones, slates, tablets, notebooks, e-readers, etc.), automotive, interior architecture, defense, medical and packaging. Many of these display covers employ Corning® Gorilla Glass® products, which offer superior mechanical properties including damage resistance, scratch resistance and drop performance. As a manufacturing method, chemical strengthening by ion exchange of alkali metal ions in glass, glass-ceramic and ceramic substrates has been employed for many years in the industry to provide these superior mechanical properties. Depending upon the application, a stress profile of compressive stress as a function of depth can be targeted by these ion-exchange methods to provide the targeted mechanical properties.

In a conventional ion-exchange strengthening process, a glass, glass-ceramic or ceramic substrate is brought into contact with a molten chemical salt so that alkali metal ions of a relatively small ionic diameter in the substrate are ion-exchanged with alkali metal ions of a relatively large ionic diameter in the chemical salt. As the relatively larger alkali metal ions are incorporated into the substrate, compressive stress is developed in proximity to the incorporated ions within the substrate, which provides a strengthening effect. As the typical failure mode of the substrates is associated with tensile stresses, the added compressive stress produced by the incorporation of the larger alkali metal ions serves to offset the applied tensile stress, leading to the strengthening effect.

One of the technical challenges associated with these ion-exchange strengthening processes is warpage of the strengthened substrates. In particular, warpage of the substrate can occur during or after the ion-exchange process when the ion-exchange process occurs in an asymmetric fashion between the two primary surfaces of the substrate. Asymmetries of the target substrates with regard to substrate geometries, substrate surfaces, coatings and films on the substrates, diffusivity of alkali metal ions, alkali metal ions in the salt bath and other factors may affect the extent and degree of the observed warpage of the target substrates.

Various approaches to managing warpage are employed in the industry. In general, these approaches tend to add significant cost to the production of glass, glass-ceramic and ceramic substrates employed in display applications. Warpage can cause difficulty in downstream processes associated with producing a display. For example, processes employed to make touch sensor display laminates can be prone to the formation of air bubbles in the laminates owing to the degree of warpage in the substrate. In some instances, additional thermal treatments and/or additional molten salt exposures can be employed to the substrates to counteract warpage associated with ion-exchange strengthening processes. However, these additional process steps result in significantly increased manufacturing costs. Other approaches, including post-production grinding and polishing can also counteract warpage effects, but again at significantly increased production costs.

Accordingly, there is a need for low-warp, strengthened glass, glass-ceramic and ceramic articles and ion-exchange methods for the same, including methods that offer the requisite degree of strengthening with limited yield loss and cost increases associated with warpage effects.

### SUMMARY OF THE DISCLOSURE

According to some aspects of the present disclosure, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, at least one of: (a) an exchange rate of the ion-exchanging alkali metal ions is higher into the first primary surface than into the second primary surface and (b) the second primary surface comprises one or more asymmetric features having a total surface area that exceeds a total surface area of any asymmetric features of the first primary surface. In addition, the submersing step is conducted such that a predetermined gap is maintained between the first primary surface of each of the articles.

According to some aspects of the present disclosure, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, an exchange rate of the ion-exchanging alkali metal ions is higher into the first primary surface than into the second primary surface. In addition, the submersing step is conducted such that a predetermined gap is maintained between the first primary surface of each of the articles.

According to some aspects of the present disclosure, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, the second primary surface comprises one or more asymmetric features having a total surface area that exceeds a total surface area of any asymmetric features of the first primary surface. In addition, the submersing step is conducted such that a predetermined gap is maintained between the first primary surface of each of the articles.

According to some aspects of the disclosure, a glass article is provided that includes: a glass substrate that is chemically strengthened, the glass substrate comprising a first primary surface and a second primary surface, and compressive stress regions extending from the first and second primary surfaces to respective first and second selected depths. Further, the glass article comprises a warp (A warp) of 200 microns or less.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a cross-sectional, schematic view of a pair of substrates comprising a plurality of ion-exchangeable alkali metal ions, as submersed in a bath comprising a plurality of ion-exchanging alkali metal ions such that a predetermined gap is maintained between the primary surfaces of the substrates, according to an embodiment.

FIG. 1A is a cross-sectional, schematic view of the pair of substrates and bath of FIG. 1, configured such that the predetermined gap is set by a plurality of spacers, according to an embodiment.

FIG. 1B is a cross-sectional, schematic view of the pair of substrates and bath of FIG. 1, configured such that the predetermined gap is set by a mesh sheet, according to an embodiment.

FIG. 1C is a cross-sectional, schematic view of a plurality of strengthened articles formed according to the configurations and methods depicted in FIGS. 1-1B, according to an embodiment.

FIG. 2 is a cross-sectional, schematic view of a pair of substrates comprising a plurality of ion-exchangeable alkali metal ions and a secondary film, as submersed in a bath comprising a plurality of ion-exchanging alkali metal ions such that a predetermined gap is maintained between the primary surfaces of the substrates, according to an embodiment.

FIG. 2A is a cross-sectional, schematic view of the pair of substrates and bath of FIG. 2, configured such that the predetermined gap is set by a plurality of spacers, according to an embodiment.

FIG. 2B is a cross-sectional, schematic view of the pair of substrates and bath of FIG. 2, configured such that the predetermined gap is set by a mesh sheet, according to an embodiment.

FIG. 2C is a cross-sectional, schematic view of a plurality of strengthened articles formed according to the configurations and methods depicted in FIGS. 2-2B, according to an embodiment.

FIG. 3 is a cross-sectional, schematic view of a pair of substrates comprising a plurality of ion-exchangeable alkali metal ions and a plurality of asymmetric features, as submersed in a bath comprising a plurality of ion-exchanging alkali metal ions such that a predetermined gap is maintained between the primary surfaces of the substrates, according to an embodiment.

FIG. 3A is a cross-sectional, schematic view of the pair of substrates and bath of FIG. 3, configured such that the predetermined gap is set by a plurality of spacers, according to an embodiment.

FIG. 3B is a cross-sectional, schematic view of the pair of substrates and bath of FIG. 3, configured such that the predetermined gap is set by a mesh sheet, according to an embodiment.

FIG. 3C is a cross-sectional, schematic view of a plurality of strengthened articles formed according to the configurations and methods depicted in FIGS. 3-3B, according to an embodiment.

FIGS. 4A-4D are a series of cross-sectional, schematic views depicting a plurality of clips for establishing a predetermined gap between substrates according to a method of making a strengthened article, according to an embodiment.

FIGS. 5A-5C are a series of cross-sectional, schematic views depicting configurations for establishing a predetermined gap between substrates according to a method of making a strengthened article, according to embodiments.

FIGS. 6A-6C are a series of cross-sectional, schematic views depicting a plurality of spacer sheets and clips for establishing a predetermined gap between substrates according to a method of making a strengthened article, according to an embodiment.

FIG. 7 is a cross-sectional, schematic view that depicts a configuration for establishing a predetermined gap between substrates and a gap between pairs of substrates according to a method of making a strengthened article, according to embodiments.

FIG. 8 is a plot of warp as a function of spacer thickness observed in substrates subjected to a method of making strengthened articles, according to an embodiment.

FIG. 9 is a photograph of a front view of an experimental set up employed in a method of making strengthened articles with various predetermined gaps, according to an embodiment.

FIG. 10A is a plot of warp as a function of spacer thickness observed on the beveled side of substrates with asymmetric beveled features, as subjected to a method of making strengthened articles, according to an embodiment.

FIG. 10B is a plot of warp as a function of spacer thickness observed on the non-beveled side of substrates with asymmetric beveled features, as subjected to a method of making strengthened articles, according to an embodiment.

FIG. 11 is a plot of change in warp as a function of spacer thickness observed on the anti-glare side of substrates, as subjected to a method of making strengthened articles, according to an embodiment.

FIG. 12 is a plot of warp amplitude as a function of spacer thickness observed on the anti-glare side of substrates, as subjected to a method of making strengthened articles, according to an embodiment.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, “compressive stress” (CS) and “depth of compressive stress layer” (DOL) are measured using means known in the art. For example, CS and DOL are measured by a surface stress meter using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to a modified version of Procedure C described in ASTM standard C770-98 (2013), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm. Further, the glass disc is isotropic, homogeneous and core-drilled with both faces polished and parallel. The modification also includes calculating the maximum force, Fₘₐₓ, to be applied. The maximum force (Fₘₐₓ) is the force sufficient to produce 20 MPa compressive stress. The maximum force to be applied, Fₘₐₓ, is calculated as follows according to Equation (1):

Fₘₐₓ=7.854*D*h (1)

where Fₘₐₓ is the maximum force in Newtons, D is the diameter of the glass disc, and h is the thickness of the light path. For each force applied, the stress is computed according to Equation (2):

$$σ = \frac{8 * {F}_{max}}{π * D * h} \qquad ( 2 )$$

where Fₘₐₓ is the maximum force in Newtons obtained from Equation (1), D is the diameter of the glass disc in mm, h is the thickness of the light path in mm, and σ is the stress in MPa.

As used herein, the “depth of compressive stress layer (DOL)” refers to a depth location within the strengthened article where the compressive stress generated from the strengthening process reaches zero.

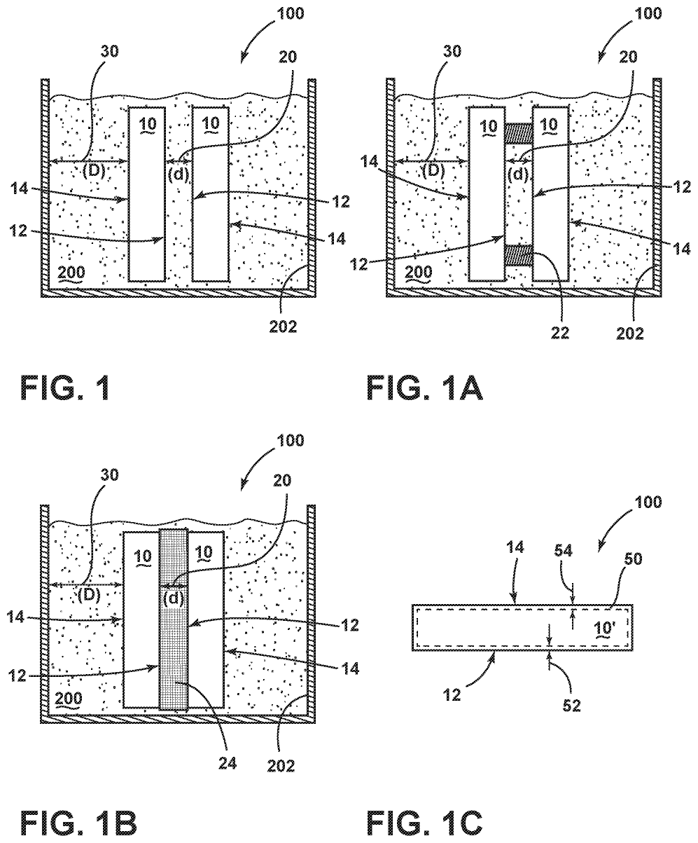

Referring to the drawings in general and to FIGS. 1-1C in particular, it will be understood that the illustrations are for the purpose of describing particular embodiments and are not intended to limit the disclosure appended claims thereto. The drawings are not necessarily to scale, and certain features and certain views of the drawings may be shown exaggerated in scale or in schematic form in the interest of clarity and conciseness.

Described in this disclosure are methods of making strengthened articles that include substrates having a glass, glass-ceramic or ceramic composition and compressive stress regions. Further, these strengthened articles are optimized to exhibit little to no warpage as a result of the methods of the disclosure, despite having features that would otherwise make them prone to warpage from asymmetric and/or non-uniform ion-exchange effects. In general, the methods of the disclosure control the kinetics of the ion-exchange process to offset any asymmetric or non-uniform ion-exchange conditions that are present in the substrates. These asymmetric or non-uniform ion-exchange conditions include the presence of secondary film(s) on some, but not all, of the surfaces of the substrates, anti-glare surfaces within some, but not all, of the surfaces of the substrates, differences in the extent of any asymmetric features on these surfaces, differences in the surface roughness of these surfaces, and other aspects of the substrates that can create non-uniform ion-exchange conditions that might otherwise make the substrates prone to warpage. Further, the methods provide ion-exchange rate control through, for example, the imposition of a predetermined gap between primary surfaces of pairs of the substrates as they are immersed in a bath containing alkali ion-exchanging ions.

The methods of making strengthened articles of the disclosure, along with the strengthened articles themselves, possess several benefits and advantages over conventional approaches to manufacturing strengthened articles comprising glass, glass-ceramic and ceramic compositions. One advantage is that the methods of the disclosure are capable of reducing the degree of warp that would otherwise be induced by non-uniform ion-exchange conditions present in the substrates. Another advantage is that the methods of the disclosure reduce or eliminate warpage without the need for additional processing steps, e.g., polishing, cutting, grinding, thermal treatments after ion exchange processing, etc. A further advantage of these methods is that they offer little to no increased capital and/or reductions in throughput relative to conventional ion-exchange processing. In particular, the additional fixtures associated with implementing the methods of the disclosure are limited in terms of size and cost (e.g., spacers, mesh, clips, etc.). Another advantage of these methods is that they result in compressive stress regions with the same or substantially similar residual stress profiles as compared to conventional ion exchange profiles, while offering the advantage of significantly reduced warpage levels in the strengthened articles produced according to the process.

Referring now to FIGS. 1-1C, a schematic illustration of a method of making strengthened articles 100 is provided. The method of making strengthened articles 100 includes: providing a plurality of substrates 10 that are each fabricated from a glass, glass-ceramic or ceramic composition with a plurality of ion-exchangeable alkali metal ions. Each of the substrates 10 also includes: a first primary surface 12 and a second primary surface 14. The method 100 further includes: providing a first ion-exchange bath 200 that resides in vessel 202. The bath 200 includes a plurality of ion-exchanging alkali metal ions, each having a larger size than the size of the ion-exchangeable alkali metal ions in the substrates 10. Finally, the method 100 includes a step of submersing the plurality of substrates 10 in the first ion-exchange bath 200 at a first ion-exchange temperature and duration to form a plurality of strengthened articles 10′ (see FIG. 1C). Each strengthened article 10′ comprises a compressive stress region 50 extending from the first and second primary surfaces 12, 14 to respective first and second selected depths 52, 54.

Referring again to FIGS. 1-1C, the method of making strengthened articles 100 can be conducted, according to an exemplary embodiment, such that at least one of: (a) an exchange rate of the ion-exchanging alkali metal ions is higher into the first primary surface 12 than into the second primary surface 14 of the substrates 10; and (b) the second primary surface 14 comprises one or more asymmetric features having a total surface area that exceeds a total surface area of any asymmetric features of the first primary surface 12 of the substrates 10. In addition, the submersing step is conducted such that a predetermined gap (d) 20 is maintained between the first primary surface 12 of each of the substrates. As noted in further detail below, the predetermined gap 20 is a relatively small gap (e.g., from about 0.01 mm to about 10 mm) between the first primary surfaces 12, as compared to a situation in which the gap between the substrates 10 is significantly larger or uncontrolled. That is, the substrates 10 employed in the method 100 are configured such that ion-exchanging alkali metal ions would be exchanged with their ion-exchangeable ions under non-uniform conditions with regard to their primary surfaces 12, 14 (and potentially result in high warpage). But, the controls afforded by the method 100, including the existence of the predetermined gap 20 (e.g., from about 0.01 mm to about 10 mm) between the first primary surfaces 12 of the substrates 10 during the submersion step, mitigate or otherwise offset these non-uniform ion-exchanging conditions associated with the substrates 10. Moreover, in some embodiments, the lack of a gap associated with the second primary surfaces 14 (or the existence of a spacing (D) 30 on the order of magnitude or greater than the predetermined gap 20 from the second primary surfaces 14 to another substrate 10 or a wall of the container holding the bath 200) also serves to create the conditions allowing the method 100 to mitigate or otherwise offset these non-uniform ion-exchanging conditions associated with the substrates 10.

In some aspects of the method of making strengthened articles 100, the rates of ion-exchange occurring at the first primary surfaces 12 of the substrates 10 would differ from the ion-exchange rates occurring at the second primary surfaces 14 of the substrates 10 for any of various reasons associated with the surfaces 12, 14. For example, variability in the surface roughness of each of the primary surfaces 12, 14 of the substrates 10 can be a source of these non-uniformities, according to some embodiments. The presence of an additional functional film, films or layers over the second primary surface 14 and not over the first primary surface 12 can also result in these potential non-uniform ion-exchange conditions. Further, the presence of anti-glare surfaces as part of, in combination with or otherwise on the primary surfaces 14 can also result in potential non-uniform ion-exchange conditions. Similarly, as noted earlier, the presence of asymmetric features on the second primary surfaces 14 of the substrates 10 that exceed the surface area of any asymmetric features on the first primary surfaces 12 can also be a source of these potential non-uniform ion-exchanging conditions.

Nevertheless, as noted earlier, the method of making strengthened articles 100 depicted in FIGS. 1-1C offers a mechanism to offset these potential ion-exchange non-uniformities in the substrates 10—i.e., the use of a predetermined gap (d) 20 between each pair of substrates 10 during the submersion step. Without being bound by theory, the predetermined gap 20 provides an additional control over the rate of alkali metal ion incorporation into the first primary surfaces 12 of the substrates 10 relative to the rate of alkali metal ion incorporation into the second primary surfaces 14. As the gap 20 is decreased in size (e.g., as relative to a situation in which the gap between the substrates 10 is significantly larger or uncontrolled, as in conventional ion exchange processes), the rate of alkali metal ion incorporation into the first primary surfaces 12 is reduced relative to the rate of alkali metal ion incorporation into the second primary surfaces 14 of the substrates 10. As a result, any propensity of the substrates 10 to experience increased ion-exchange at the first primary surfaces 12 relative to the second primary surfaces 14 can be offset by the presence of the predetermined gap 20. Without being bound by theory, it is believed that the predetermined gap 20 controls the kinetics of the ion-exchange process, particularly the rate in which ion-exchangeable alkali metal ions are exchanged out of the substrates 10 and replaced with ion-exchanging alkali metal ions from the bath 200. Also, and without being bound by theory, it is believed that a lower limit to the predetermined gap 20 can exist according to the method 100 where the beneficial effects of the gap 20 on reducing warpage are ultimately offset by capillary effects which will inhibit the exchange rate of the ion-exchanging alkali metal ions into the substrates 10.

Referring to FIGS. 1-1B, the predetermined gap (d) 20 between the substrates 10 employed during the submersion step of the method of making strengthened articles 100 can range from 0.01 mm to about 5 mm. Hence, the predetermined gap 20 is a controlled gap between the substrates 10. In some implementations, the predetermined gap 20 can range from about 0.01 mm to about 10 mm, from about 0.01 mm to about 7.5 mm, from about 0.01 mm to about 5 mm, from about 0.01 mm to about 2.5 mm, from about 0.01 mm to about 1 mm, from about 0.01 mm to about 0.9 mm, from about 0.01 mm to about 0.8 mm, from about 0.01 mm to about 0.7 mm, from about 0.01 mm to about 0.6 mm, from about 0.01 mm to about 0.5 mm, from about 0.02 mm to about 10 mm, from about 0.02 mm to about 7.5 mm, from about 0.02 mm to about 5 mm, from about 0.02 mm to about 2.5 mm, from about 0.02 mm to about 1 mm, from about 0.02 mm to about 0.9 mm, from about 0.02 mm to about 0.8 mm, from about 0.02 mm to about 0.7 mm, from about 0.02 mm to about 0.6 mm, from about 0.02 mm to about 0.5 mm, and all values between these gap endpoints. In some implementations, the predetermined gap 20 between the substrates 10 employed during the submersion step of the method of making strengthened articles 100 can be 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.5 mm, 2.0 mm, 2.5 mm, 3.0 mm, 3.5 mm, 4.0 mm, 4.5 mm, 5.0 mm, 7.5 mm, 10.0 mm, and all predetermined gaps 20 between these values.

According to an additional implementation of the method of making the strengthened articles 100 depicted in FIGS. 1-1B, the predetermined gap (d) 20 is smaller than a spacing (D) 30 from the second primary surface 14 of each of the substrates 10 to another substrate (e.g., to a second primary surface 14 of another substrate 10) or a wall of a vessel 202 holding the bath 200. According to a further implementation, the predetermined gap (d) 20 is 1% of or less, 5% of or less, 10% of or less, 20% of or less, 25% of or less, 50% of or less, 75% of or less, 100% of or less, 150% of or less, 200% of or less, than a spacing (D) 30 from the second primary surface 14 of each of the substrates 10 to another substrate (e.g., a substrate 10) or a wall of a vessel 202 holding the bath 200. According to a further implementation, the spacing (D) 30 from the second primary surface 14 of each of the substrates 10 to another substrate or a wall of a vessel 202 is at least 5 mm, at least 7.5 mm, at least 10.0 mm, at least 12.5 mm, at least 15 mm, and the spacing (D) 30 levels between or exceeding these values. According to another implementation, the ratio of the predetermined gap (d) 20 to the spacing (D) 30 can be set such that d/D≤0.1, d/D≤0.05, or even d/D≤0.01.

Referring now to FIG. 1A, a method of making strengthened articles 100 is depicted in which the predetermined gap (d) 20 is set by a plurality of spacers 22. In implementations, the spacers 22 have the same, or substantially similar, thickness dimensions as the predetermined gap 20. Further, according to aspects, any number of spacers 22 can be employed between the substrates 10 within the bath 200, as shown in FIG. 1A. In an embodiment, a spacer 22 is placed between each pair of substrates 10 at their corners to minimize the surface area of the substrates that are masked by the spacers themselves. In another implementation, the spacers 22 are in the form of wires that are placed between each pair of substrates 10, which can minimize the surface area of the substrates that are masked by the spacers 22. The spacers 22 can be fabricated from various materials that are non-reactive with the bath 200 and glass, glass-ceramic and ceramic compositions of the substrates 10 including, but not limited to, 300 series stainless steel, aluminum alloys, aluminum metal, platinum, platinum alloys, nickel alloys, In800 alloys, Cr—Mo alloys, silica, alumina, zirconia and polymeric-coated aspects of these materials. Further, the spacers 22 can take on any of a variety of shapes and structures including but not limited to wires, cylindrical-shaped washers, cubic-shaped washers, rectangular-shaped washers, sheets, shims, clips, braces, supports, etc.

Referring now to FIG. 1B, a method of making strengthened articles 100 is depicted in which the predetermined gap 20 (d) is set by a mesh 24. In implementations, the mesh 24 has the same, or substantially similar, thickness dimensions as the predetermined gap 20. Further, according to aspects, any of a variety of a number of types of mesh 24 (i.e., various levels of filtering) can be employed between the substrates 10 within the bath 200, as shown in FIG. 1B. The mesh 24 can be fabricated from various materials that are non-reactive with the bath 200 and glass, glass-ceramic and ceramic compositions of the substrates 10 including, but not limited to, 300 series stainless steel, aluminum alloys, aluminum metal, platinum, platinum alloys, nickel alloys, In800 alloys, Cr—Mo alloys, silica, alumina, zirconia and polymeric-coated aspects of these materials.

Referring to FIG. 1C, strengthened articles 10′ are produced from the method of making strengthened articles 100. As noted earlier, these strengthened articles 10′ possess a compressive stress region 50 that extends to first and second selected depths 52, 54 from the respective first and second primary surfaces 12, 14. Further, implementations of the methods of making strengthened articles 100 result in strengthened articles 10′ with minimal to no warp. According to some embodiments, the method 100 results in strengthened articles 10′ that comprise a warp (Δ warp) of about 200 microns or less. In some implementations, the warp (Δ warp) of the articles 10′ is about 300 microns or less, about 250 microns or less, about 200 microns or less, about 175 microns or less, about 150 microns or less, about 125 microns or less, about 100 microns or less, about 75 microns or less, about 50 microns or less, about 25 microns or less, and all levels of warp between these levels. Similarly, the method 100 can result in strengthened articles 10′ that exhibit a maximum warpage of less than 0.5% of the longest dimension of the article 10′, less than 0.1% of the longest dimension of the article 10′, or even less than 0.01% of the longest dimension of the article 10′. For example, strengthened articles 10′ in the form of 150 mm×75 mm cell phone covers can be produced according to the method 100 with a warpage of less than 0.15 mm, indicative of a warpage of less 0.01% in their longest dimension.

The substrates 10 employed in the method of making strengthened articles 100 can comprise various glass compositions, glass-ceramic compositions and ceramic compositions. The choice of glass is not limited to a particular glass composition. For example, the composition chosen can be any of a wide range of silicate, borosilicate, aluminosilicate, or boroaluminosilicate glass compositions, which optionally can comprise one or more alkali and/or alkaline earth modifiers.

By way of illustration, one family of compositions that may be employed in the substrates 10 includes those having at least one of aluminum oxide or boron oxide and at least one of an alkali metal oxide or an alkaline earth metal oxide, wherein—15 mol %≤(R₂O+R′O—Al₂O₃—ZrO₂)—B₂O₃≤4 mol %, where R can be Li, Na, K, Rb, and/or Cs, and R′ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. Pat. Nos. 8,969,226 and 8,652,978, hereby incorporated by reference in their entirety as if fully set forth below.

Another illustrative family of compositions that may be employed in the substrates 10 includes those having at least 50 mol % SiO₂ and at least one modifier selected from the group consisting of alkali metal oxides and alkaline earth metal oxides, wherein [(Al₂O₃ (mol %)+B₂O₃ (mol %))/(Σ alkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described more fully in U.S. Pat. No. 8,586,492, hereby incorporated by reference in its entirety as if fully set forth below.

Yet another illustrative family of compositions that may be employed in the substrates 10 includes those having SiO₂, Al₂O₃, P₂O₅, and at least one alkali metal oxide (R₂O), wherein 0.75≤[(P₂O₅ (mol %)+R₂O (mol %))/M₂O₃ (mol %)]≤1.2, where M₂O₃═Al₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271, hereby incorporated by reference in its entirety as if fully set forth below.

Yet another illustrative family of compositions that can be employed in the substrates 10 includes those having at least about 4 mol % P₂O₅, wherein (M₂O₃ (mol %)/RₓO (mol %))<1, wherein M₂O3=Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. patent application Ser. No. 13/678,013 and U.S. Pat. No. 8,765,262, the contents of which are hereby incorporated by reference in their entirety as if fully set forth below.

Still another illustrative family of compositions that can be employed in the substrates 10 includes those having Al₂O₃, B₂O₃, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO₂; at least about 10 mol % R₂O, wherein R₂O comprises Na₂O; Al₂O₃, wherein −0.5 mol %≤Al₂O₃ (mol %)-R₂O (mol %)≤2 mol %; and B₂O₃, and wherein B₂O₃ (mol %)-(R₂O (mol %)-Al₂O₃ (mol %))≥4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≤MgO+ZnO≤6 mol %; and, optionally, at least one of CaO, BaO, and SrO, wherein 0 mol %≤CaO+SrO+BaO≤2 mol %. Such glasses are more fully described in U.S. patent application Ser. No. 13/903,398, the content of which is incorporated herein by reference in its entirety as if fully set forth below.

Unless otherwise noted, the strengthened articles (e.g., articles 10′) and associated methods (e.g., method 100) for producing them outlined in this disclosure are exemplified by being fabricated from substrates 10 having an alumino-silicate glass composition of 68.96 mol % SiO₂, 0 mol % B₂O₃, 10.28 mol % Al₂O₃, 15.21 mol % Na₂O, 0.012 mol % K₂O, 5.37 mol % MgO, 0.0007 mol % Fe₂O₃, 0.006 mol % ZrO₂, and 0.17 mol % SnO₂. A typical aluminosilicate glass is described in U.S. patent application Ser. No. 13/533,298, and hereby incorporated by reference.

Similarly, with respect to ceramics, the material chosen for the substrates 10 employed in the method of making strengthened articles 100 can be any of a wide range of inorganic crystalline oxides, nitrides, carbides, oxynitrides, carbonitrides, and/or the like. Illustrative ceramics include those materials having an alumina, aluminum titanate, mullite, cordierite, zircon, spinel, persovskite, zirconia, ceria, silicon carbide, silicon nitride, silicon aluminum oxynitride, or zeolite phase.

Similarly, with respect to glass-ceramics, the material chosen for the substrates 10 can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The strengthened articles 10′ resulting from the method of making strengthened articles 100 can adopt a variety of physical forms, including a glass substrate. That is, from a cross-sectional perspective, the article 10′, when configured as a substrate, can be flat or planar, or it can be curved and/or sharply-bent. Similarly, the article 10′ can be a single unitary object, a multi-layered structure, or a laminate. When the article 10′ is employed in a substrate or plate-like form, the thickness of the article 10′ is preferably in the range of about 0.2 to 1.5 mm, and more preferably in the range of about 0.8 to 1 mm. Further, the article 10′ can possess a composition that is substantially transparent in the visible spectrum, and which remains substantially transparent after the development of its compressive stress region 50.

Regardless of its composition or physical form, the strengthened article 10′, as resulting from the method of making strengthened articles 100, will include a region 50 under compressive stress that extends inward from a surface (e.g., first and second primary surfaces 12, 14) to a specific depth therein (e.g., the first and second selected depths 52, 54). The amount of compressive stress (CS) and the depth of compressive stress layer (DOL) associated with the compressive stress region 50 can be varied based on the particular use for the articles 10′ formed according to the method 100. One general limitation, particularly for an article 10′ having a glass composition, is that the CS and DOL should be limited such that a tensile stress created within the bulk of the article 10′, as a result of the compressive stress region 50, does not become so excessive as to render the article frangible.

In certain aspects of the disclosure, compressive stress (CS) profiles of strengthened articles 10′ having a glass composition that were strengthened using an ion exchange process according to the method 100 of making strengthened articles were determined using a method for measuring the stress profile based on the TM and TE guided mode spectra of the optical waveguide formed in the ion-exchanged glass (hereinafter referred to as the “WKB method”). The method includes digitally defining positions of intensity extrema from the TM and TE guided mode spectra, and calculating respective TM and TE effective refractive indices from these positions. TM and TE refractive index profiles n_{TM}(z) and n_{TE}(z) are calculated using an inverse WKB calculation. The method also includes calculating the stress profile S(z)=[n_{TM}(z)−n_{TM}(z)]/SOC, where SOC is a stress optic coefficient for the glass substrate. This method is described in U.S. patent application Ser. No. 13/463,322 by Douglas C. Allan et al., entitled “Systems and Methods for Measuring the Stress Profile of Ion-Exchanged Glass,” filed May 3, 2012, and claiming priority to U.S. Provisional Patent Application No. 61/489,800, filed May 25, 2011, the contents of which are incorporated herein by reference in their entirety. Other techniques for measuring stress levels in these articles as a function of depth are outlined in U.S. Provisional Application Nos. 61/835,823 and 61/860,560, hereby incorporated by reference.

Referring again to FIGS. 1-1C, a method of making strengthened articles 100, e.g., for developing the compressive stress region 50 in the articles 10′, involves submersing a pair of substrates 10 in a strengthening bath 200. In some aspects, the bath 200 contains a plurality of ion-exchanging metal ions and the substrates 10 have a glass composition with a plurality of ion-exchangeable metal ions. For example, the bath may contain a plurality of potassium ions that are larger in size than ion-exchangeable ions in the substrates 10, such as sodium. The ion-exchanging ions in the bath 200 will preferentially exchange with the ion-exchangeable ions in the substrates 10.

In certain aspects, the strengthening bath 200 employed to create the compressive stress region 50 comprises a molten KNO₃ bath at a concentration approaching 100% by weight with additives, as understood by those with ordinary skill in the field, or at a concentration of 100% by weight. Such a bath is sufficiently heated to a temperature to ensure that the KNO₃ remains in a molten state during processing of the substrates 10. The strengthening bath 200 may also include a combination of KNO₃ and one or both of LiNO₃ and NaNO₃.

According to some aspects of the disclosure, a method for making strengthened articles 100 is provided that includes developing a compressive stress region 50 in strengthened articles 10′ with a maximum compressive stress of about 400 MPa or less and a first selected depth 52 of at least 8% of the thickness of the articles 10′. The articles 10′ comprise substrates 10 having an alumino-silicate glass composition and the method 100 involves submersing the substrates 10 in a strengthening bath 200 held at a temperature in a range from about 400° C. to 500° C. with a submersion duration between about 3 and 60 hours. More preferably, the compressive stress region 50 can be developed in the strengthened articles 10′ by submersing the substrates 10 in a strengthening bath 200 at a temperature ranging from about 420° C. to 500° C. for a duration between about 0.25 to about 50 hours. In certain aspects, an upper temperature range for the strengthening bath is set to be about 30° C. less than the anneal point of the substrates 10 (e.g., when the substrates 10 possess a glass or a glass-ceramic composition). Particularly preferable durations for the submersion step range from 0.5 to 25 hours. In certain embodiments, the strengthening bath 200 is held at about 400° C. to 450° C., and the first ion exchange duration is between about 3 and 15 hours.

In one exemplary aspect, the substrates 10 are submersed in a strengthening bath 200 at 450° C. that includes about 41% NaNO₃ and 59% KNO₃ by weight for a duration of about 10 hours to obtain a compressive stress region 50 with a DOL>80 μm and a maximum compressive stress of 300 MPa or less (e.g., for a strengthened article 10′ having at thickness about 0.8 to 1 mm) In another example, the strengthening bath 200 includes about 65% NaNO₃ and 35% KNO₃ by weight, is held at 460° C., and the submersion step is conducted for about 40 to 50 hours to develop a compressive stress region 50 with a maximum compressive stress of about 160 MPa or less with a DOL of about 150 μm or more (e.g., for an article 10′ having a thickness of about 0.8 mm).

For alumino-silicate glass substrates 10 having a thickness of about 0.3 to 0.8 mm, a DOL>60 μm can be achieved in strengthened articles 10′ made according to the methods 100 of the disclosure with a strengthening bath 200 composition in the range of 40 to 60% NaNO₃ by weight (with a balance being KNO₃) held at a temperature of 450° C. with a submersion duration between about 5.5 to 15 hours. Preferably, the submersion duration is between about 6 to 10 hours and the strengthening bath 200 is held at a composition in the range of 44 to 54% NaNO₃ by weight (with a balance KNO₃).

For embodiments of the method of making strengthened articles 100, in which the strengthened articles 10′ are derived from substrates 10 containing alumino-silicate glass with appreciable amounts of P₂O₅, the strengthening bath 200 can be held at somewhat lower temperatures to develop a similar compressive stress region 50. For example, the strengthening bath can be held as low as 380° C. with similar results, while the upper range outlined in the foregoing remains viable. In a further aspect, the substrates 10 may possess a lithium-containing glass composition and appreciably lower temperature profiles can be employed, according to the method 100, to generate a similar compressive stress region 50 in the resulting strengthened articles 10′. In these aspects, the strengthening bath 200 is held at a temperature ranging from about 350° C. to about 500° C., and preferably from about 380° C. to about 480° C. The submersion times for these aspects range from about 0.25 hours to about 50 hours and, more preferably, from about 0.5 to about 25 hours.

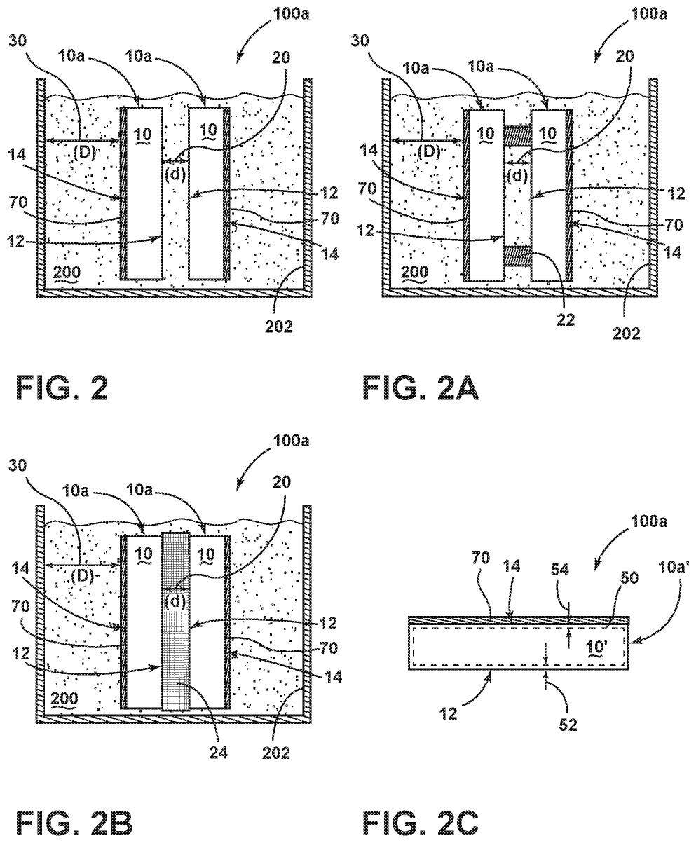

Referring now to FIGS. 2-2C, a schematic illustration of a method of making strengthened articles 100a is provided. The method 100a depicted in FIGS. 2-2C is essentially the same as the method 100 depicted in FIGS. 1-1C; consequently, like-numbered elements have the same or substantially similar functions and/or structure. The method of making strengthened articles 100a includes: providing a plurality of articles 10a that comprise substrates 10 fabricated from a glass, glass-ceramic or ceramic composition with a plurality of ion-exchangeable alkali metal ions. Each of the substrates 10 also includes: a first primary surface 12 and a second primary surface 14. The articles 10a also include a secondary film 70, which is a coating, surface, film or layer disposed on, within, or over the second primary surfaces 14. The secondary film 70 can be any of a number of functional films or surfaces, as understood by those of ordinary skill in the field of the disclosure, such as an anti-fingerprint film, scratch-resistant film, anti-reflective film, anti-glare layer, anti-glare surface (e.g., as formed through an etching process according to process conditions understood by those with ordinary skill in the field of the disclosure that are suitable for the particular composition of the substrate 10), and combinations thereof. The method 100a further includes: providing a first ion-exchange bath 200 that resides in vessel 202. The bath 200 includes a plurality of ion-exchanging alkali metal ions, each having a larger size than the size of the ion-exchangeable alkali metal ions in the substrates 10. Finally, the method 100a includes a step of submersing the plurality of articles 10a in the first ion-exchange bath 200 at a first ion-exchange temperature and duration to form a plurality of strengthened articles 10a′ (see FIG. 2C). Each strengthened article 10a′ comprises a compressive stress region 50 extending from the first and second primary surfaces 12, 14 to respective first and second selected depths 52, 54.

Referring again to FIGS. 2-2C, the method of making strengthened articles 100a is conducted such that the exchange rate of the ion-exchanging alkali metal ions is higher into the first primary surface 12 than into the second primary surface 14 of the substrates 10a. In particular, the presence of the secondary film 70 over the second primary surfaces 14 of the substrates 10 creates a condition such that the exchange rate of the ion-exchanging alkali metal ions is higher into the first primary surface 12 than into the second primary surface 14. In addition, the submersing step is conducted such that a predetermined gap (d) 20 is maintained between the first primary surface 12 of each of the substrates 10. That is, the substrates 10 (and articles 10a) employed in the method 100a are configured such that ion-exchanging alkali metal ions would be exchanged with their ion-exchangeable ions under non-uniform conditions with regard to their primary surfaces 12, 14 (and potentially result in high warpage). But, the controls afforded by the method 100a, including the existence of the predetermined gap 20 during the submersion step, mitigate or otherwise offset these non-uniform ion-exchanging conditions associated with the substrates 10.

Nevertheless, as noted earlier, the method of making strengthened articles 100a depicted in FIGS. 2-2C offers a mechanism to offset these potential ion-exchange non-uniformities in the articles 10a—i.e., the use of a predetermined gap 20 (d) between each pair of substrates 10 during the submersion step. Without being bound by theory, the predetermined gap 20 provides an additional control over the rate of alkali metal ion incorporation into the first primary surfaces 12 of the substrates 10 relative to the rate of alkali metal ion incorporation into the second primary surfaces 14. As the gap 20 is decreased in size, the rate of alkali metal ion incorporation into the first primary surfaces 12 is reduced relative to the rate of alkali metal ion incorporation into the second primary surfaces 14 of the substrates 10. As a result, any propensity of the substrates 10 to experience increased ion-exchange at the first primary surfaces 12 relative to the second primary surfaces 14 (i.e., by virtue of the presence of the secondary films 70 on or over the primary surfaces 14) can be offset by the presence of the gap 20. Without being bound by theory, it is believed that the gap 20 controls the kinetics of the ion-exchange process, particularly the rate in which ion-exchangeable alkali metal ions are exchanged out of the substrates 10 and replaced with ion-exchanging alkali metal ions from the bath 200.

Referring again to FIGS. 2-2B, the predetermined gap (d) 20 between the substrates 10 employed during the submersion step of the method of making strengthened articles 100a can range from 0.01 mm to about 5 mm. In some implementations, the predetermined gap 20 can range from about 0.01 mm to about 10 mm, from about 0.01 mm to about 7.5 mm, from about 0.01 mm to about 5 mm, from about 0.01 mm to about 2.5 mm, from about 0.01 mm to about 1 mm, from about 0.01 mm to about 0.9 mm, from about 0.01 mm to about 0.8 mm, from about 0.01 mm to about 0.7 mm, from about 0.01 mm to about 0.6 mm, from about 0.01 mm to about 0.5 mm, from about 0.02 mm to about 10 mm, from about 0.02 mm to about 7.5 mm, from about 0.02 mm to about 5 mm, from about 0.02 mm to about 2.5 mm, from about 0.02 mm to about 1 mm, from about 0.02 mm to about 0.9 mm, from about 0.02 mm to about 0.8 mm, from about 0.02 mm to about 0.7 mm, from about 0.02 mm to about 0.6 mm, from about 0.02 mm to about 0.5 mm, and all values between these gap endpoints. In some implementations of the method of making the strengthened articles 100a depicted in FIGS. 2-2B, the predetermined gap 20 between the substrates 10 employed during the submersion step of the method of making strengthened articles 100 can be 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.5 mm, 2.0 mm, 2.5 mm, 3.0 mm, 3.5 mm, 4.0 mm, 4.5 mm, 5.0 mm, 7.5 mm, 10 mm, and all predetermined gaps 20 between these values.

According to an additional implementation of the method of making the strengthened articles 100a depicted in FIGS. 2-2B, the predetermined gap (d) 20 is smaller than a spacing (D) 30 from the second primary surface 14 of each of the substrates 10 to another substrate (e.g., to a second primary surface 14 of another substrate 10) or a wall of a vessel 202 holding the bath 200. According to a further implementation, the predetermined gap (d) 20 is 1% of or less, 5% of or less, 10% of or less, 20% of or less, 25% of or less, 50% of or less, 75% of or less, 100% of or less, 150% of or less, or 200% of or less, than a spacing (D) 30 from the second primary surface 14 of each of the substrates 10 to another substrate (e.g., a substrate 10) or a wall of a vessel 202 holding the bath 200. According to a further implementation, the spacing (D) 30 from the second primary surface 14 of each of the substrates 10 to another substrate or a wall of a vessel 202 is at least 5 mm, at least 7.5 mm, at least 10.0 mm, at least 12.5 mm, at least 15 mm, and spacing (D) 30 levels between or exceeding these values. According to another implementation, the ratio of the predetermined gap (d) 20 to the spacing (D) 30 can be set such that d/D≤0.1, d/D≤0.05, or even d/D≤0.01.

Referring now to FIG. 2A, a method of making strengthened articles 100a is depicted in which the predetermined gap (d) 20 is set by a plurality of spacers 22. In implementations, the spacers 22 have the same, or substantially similar, thickness dimensions as the predetermined gap 20. Further, according to aspects, any number of spacers 22 can be employed between the substrates 10 within the bath 200, as shown in FIG. 2A. In a preferred embodiment, a spacer 22 is placed between each pair of substrates 10 at their corners to minimize the surface area of the substrates that are masked by the spacers themselves. The spacers 22 can be fabricated from various materials that are non-reactive with the bath 200 and glass, glass-ceramic and ceramic compositions of the substrates 10 including, but not limited to, 300 series stainless steel, nickel alloys, aluminum alloys, aluminum metal, platinum, platinum alloys, In800 alloys, Cr—Mo alloys, silica, alumina, zirconia and polymeric-coated aspects of these materials. Further, the spacers 22 employed in the method of making strengthened articles 100a (as also described earlier in connection with FIGS. 1A and 1B) can take on any of a variety of shapes and structures including but not limited to wires, cylindrical-shaped washers, cubic-shaped washers, rectangular-shaped washers, sheets, shims, clips, braces, supports, etc.

Referring now to FIG. 2B, a method of making strengthened articles 100a is depicted in which the predetermined gap (d) 20 is set by a mesh 24. In implementations, the mesh 24 has the same, or substantially similar, thickness dimensions as the predetermined gap 20. Further, according to aspects, any of a variety of a number of types of mesh 24 (i.e., various levels of filtering) can be employed between the substrates 10 within the bath 200, as shown in FIG. 2B. The mesh 24 can be fabricated from various materials that are non-reactive with the bath 200 and glass, glass-ceramic and ceramic compositions of the substrates 10 including, but not limited to, 300 series stainless steel, nickel alloys, aluminum alloys, aluminum metal, platinum, platinum alloys, In800 alloys, Cr—Mo alloys, silica, alumina, zirconia and polymeric-coated aspects of these materials.

Referring to FIG. 2C, strengthened articles 10a′ are produced from the method of making strengthened articles 100a. As noted earlier, these strengthened articles 10a′ possess a compressive stress region 50 that extends to first and second selected depths 52, 54 from the respective first and second primary surfaces 12, 14. Further, implementations of the methods of making strengthened articles 100a result in strengthened articles 10a′ with minimal to no warp. According to some embodiments, the method 100a results in strengthened articles 10a′ that comprise a warp (Δ warp) of about 200 microns or less. In some implementations, the warp (Δ warp) of the articles 10a′ is about 300 microns or less, about 250 microns or less, about 200 microns or less, about 175 microns or less, about 150 microns or less, about 125 microns or less, about 100 microns or less, about 75 microns or less, about 50 microns or less, about 25 microns or less, and all levels of warp between these levels. Similarly, the method 100a can result in strengthened articles 10a′ that exhibit a maximum warpage of less than 0.5% of the longest dimension of the article 10a′, less than 0.1% of the longest dimension of the article 10a′, or even less than 0.01% of the longest dimension of the article 10a′.

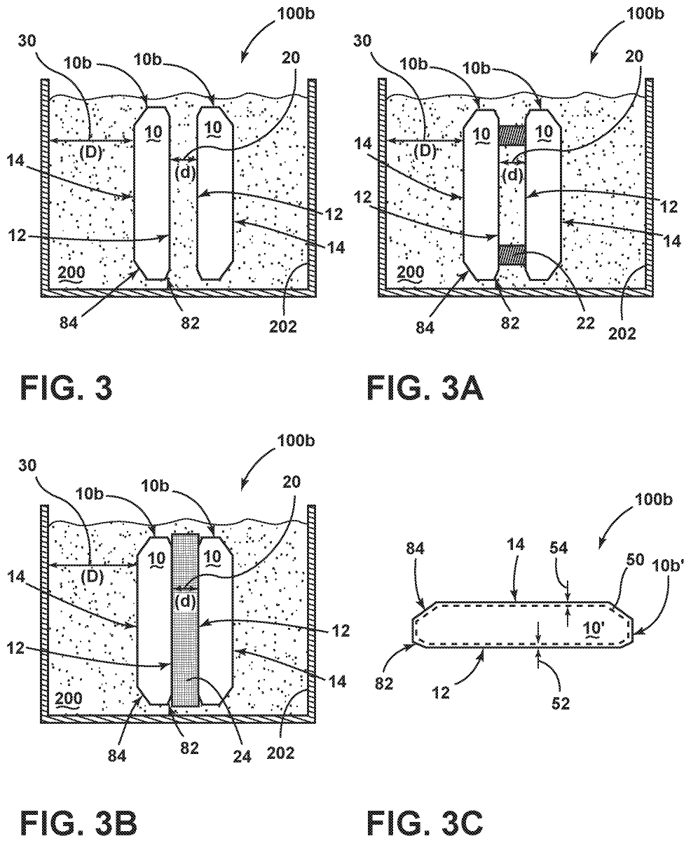

Referring now to FIGS. 3-3C, a schematic illustration of a method of making strengthened articles 100b is provided. The method 100b depicted in FIGS. 3-3C is essentially the same as the method 100 depicted in FIGS. 1-1C; consequently, like-numbered elements (e.g., spacers 22) have the same or substantially similar functions and/or structure. The method of making strengthened articles 100b includes: providing a plurality of articles 10b that comprise substrates 10 fabricated from a glass, glass-ceramic or ceramic composition with a plurality of ion-exchangeable alkali metal ions. Each of the substrates 10 also includes: a first primary surface 12 and a second primary surface 14. The articles 10b also include a plurality of asymmetric features 84 on the second primary surface 14 and an optional plurality of asymmetric features 82 on the first primary surface 12 of the substrates 10. Further, the plurality of asymmetric features 84 on the second primary surface 14 has a total surface area that exceeds the plurality of asymmetric features 82 on the first primary surface 12, to the extent that the asymmetric features 82 are present. In addition, the asymmetric features 82, 84 can be any of a variety of forms including, but not limited to, chamfered, beveled, rounded, and angled edges. Essentially, the asymmetric features 82, 84, as present in the substrates 10 of the articles 10b, present a condition in which ion-exchange into the first and second primary surfaces 12, 14 of the substrates would occur in a non-uniform fashion, without the additional controls afforded by the method 100b. Accordingly, these asymmetric features 82, 84 present a condition that would otherwise lead to an asymmetric ion-exchange within the substrates 10 that could lead to excessive warpage. Nevertheless, the additional controls provided by the method of making strengthened articles 100b depicted in FIGS. 3-3C (e.g., the use of the predetermined gap (d) 20 according to the method 100b), results in further asymmetric ion exchange levels between the first and second primary surfaces 12 and 14, which can counteract the effects of the asymmetric features 82, 84 in terms of warpage.

Referring again to FIGS. 3-3C, the method 100b further includes: providing a first ion-exchange bath 200 that resides in vessel 202. The bath 200 includes a plurality of ion-exchanging alkali metal ions, each having a larger size than the size of the ion-exchangeable alkali metal ions in the substrates 10. Finally, the method 100b includes a step of submersing the plurality of articles 10b in the first ion-exchange bath 200 at a first ion-exchange temperature and duration to form a plurality of strengthened articles 10b′ (see FIG. 3C). Each strengthened article 10b′ comprises a compressive stress region 50 extending from the first and second primary surfaces 12, 14 to respective first and second selected depths 52, 54. Further, the strengthened articles 10b′ produced according to the method 100b depicted in FIGS. 3-3C have the same, or substantially the same, properties as the strengthened articles 10′ and 10a′ produced according to the methods 100, 100a depicted in FIGS. 1-1C, 2-2C.

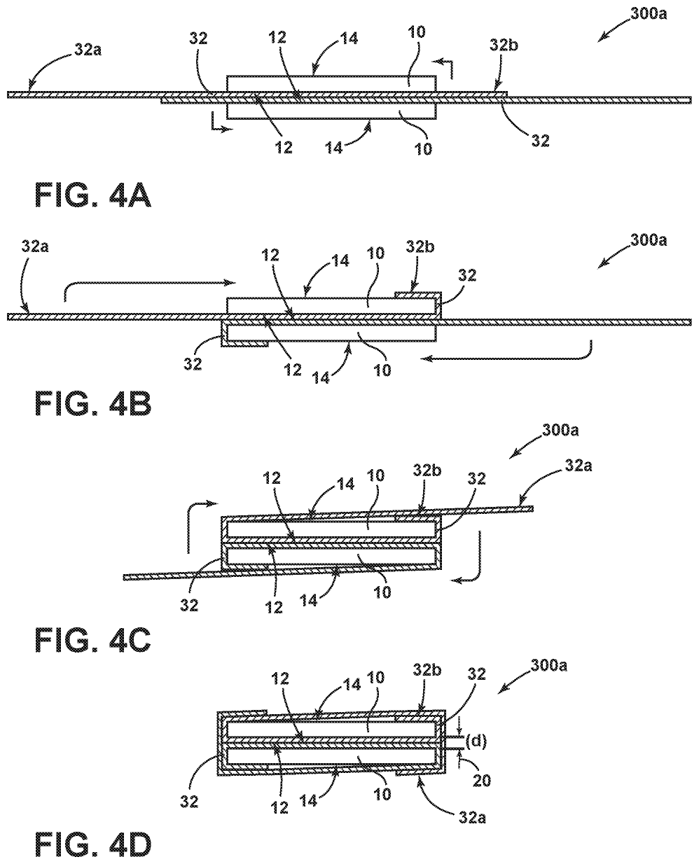

Referring now to FIGS. 4A-4D, a series of cross-sectional, schematic views depicts a method 300a for preparing a plurality of substrates 10 with a predetermined gap (d) 20 (FIG. 4D) set by virtue of an arrangement of clips 32 between their first primary surfaces 12. As shown in FIG. 4A, a pair of clips 32 with long and short ends 32a and 32b, respectively, are arranged between the first primary surfaces 12 of the substrates 10. As shown in FIG. 4B, the short ends 32b of the clips 32 are bent around edges of the substrates 10 and into contact with the second primary surfaces 14. Now referring to FIG. 4C, the long ends 32a of the clips 32 are bent around opposite edges of the substrates 10 and into contact with the second primary surfaces 14 and short ends 32b of the clips 32. As shown in FIG. 4D, the long ends 32a of the clips 32 are now bent back around the edges of the substrates 10 and into contact with long ends 32a of the opposite clips and as disposed over the second primary surfaces 14 of the substrates 10. As such, the method 300a can be employed to fashion the clips 32 around the substrates 10 to result in a predetermined gap 20 between the first primary surfaces 12, which can be employed as part of the methods of making strengthened articles 100, 100a and 100b depicted in FIGS. 1-1C, 2-2C and 3-3C and described earlier.

Referring again to FIGS. 4A-4D, the clips 32 can be fabricated with a width that is shorter than the width of the substrates 10 (not shown), which maximizes the exposure of the primary surfaces 12, 14 of the substrates 10 to the ion-exchange bath 200 employed by the methods of making strengthened articles 100, 100a and 100b (see FIGS. 1-3C). Further, the clips 32 can be fabricated from any of a variety of materials that are non-reactive with regard to the ion-exchange bath 200 and the substrates 10 themselves, while having a level of ductility sufficient to afford the bending depicted in exemplary form in FIGS. 4B-4D. Suitable materials for the clips 32 include 300 series stainless steel, nickel alloys, aluminum alloys, aluminum metal, platinum, platinum alloys, In800 alloys, Cr—Mo alloys and other alloys as understood by those with ordinary skill in the field of the disclosure. In addition, the particular arrangement of the clips 32 outlined in FIGS. 4A-4D is exemplary; consequently, those with ordinary skill in the field of the disclosure can readily apply the principles set forth in this embodiment with a different sequence of bending and/or arrangement around the substrates 10 to accomplish the same function, i.e., the development of a predetermined gap (d) 20 between the first primary surfaces 12 of the substrates 10.

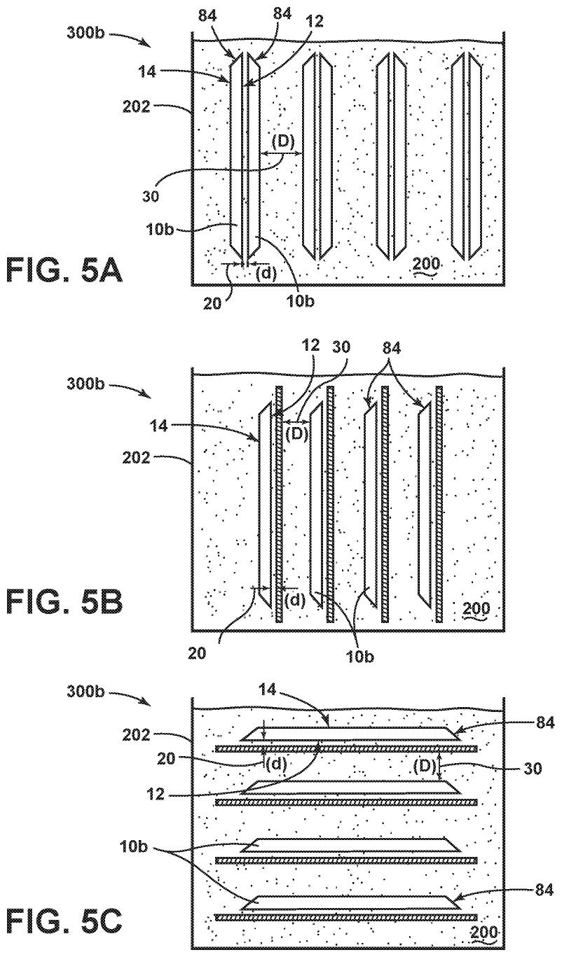

Referring now to FIGS. 5A-5C, a series of cross-sectional, schematic views depicting configurations for establishing a predetermined gap (d) 20 between substrates 10b, according to a method of making a strengthened article 300b, is provided, according to embodiments of the disclosure. More particularly, the embodiments of the method 300b set forth in FIGS. 5A-5C are exemplary of approaches for scaling up the methods 100, 100a, 100b depicted in FIGS. 1-3C to produce larger quantities of strengthened articles consistent with the principles of the disclosure. According to the method 300b depicted in exemplary form in FIGS. 5A-5C, pairs of substrates 10b with asymmetric features 84 on their second primary surfaces 14 are arranged in a vessel 202 containing an ion-exchange bath 200 in various configurations to develop a predetermined gap 20 between the first primary surfaces 12 of these substrates. As shown in FIG. 5A, the pairs of substrates 10b are arranged vertically in the vessel 202 within the bath 200 and the predetermined gap (d) 20 is located in the horizontal direction between each of the pairs of substrates 10b and, further, the pairs of substrates are separated by a spacing (D) 30. In this configuration, the predetermined gap (d) 20 and spacing (D) 30 can be developed through any of the approaches outlined earlier, e.g., with spacers, wires, shims, sheets, a mesh, clips, etc. (not shown in FIG. 5A).

Referring now to FIG. 5B, the individual substrates 10b are arranged vertically in the vessel 202 within the bath 200 and the predetermined gap 20 (d) is located in the horizontal direction between each of the substrates 10b and a dividing sheet comprising a material (e.g., a series 300 stainless steel alloy) that is non-reactive with regard to the composition of the substrates 10b and the ion-exchange bath 200. Further, a spacing (D) 30 separates a dividing sheet with the next adjacent substrate 10b. In this configuration, the predetermined gap (d) 20 and spacing (D) 30, with regard to the dividing sheet and the primary surface 12 of each substrate 10b, can be developed through any of the approaches outlined earlier, e.g., with spacers, a mesh, clips, etc. (not shown in FIG. 5B).

Referring to FIG. 5C, the individual substrates 10b are arranged horizontally in the vessel 202 within the bath 200 and the predetermined gap (d) 20 is located in the vertical direction between each of the substrates 10b and a dividing sheet comprising a material that is non-reactive with regard to the composition of the substrates 10b and the ion-exchange bath 200. Further, a spacing (D) 30 separates a dividing sheet with the next adjacent substrate 10b. In this configuration, the predetermined gap (d) 20 and spacing (D) 30, with regard to the dividing sheet and the primary surface 12 of each substrate 10b, can be developed through any of the approaches outlined earlier, e.g., with spacers, a mesh, clips, etc. (not shown in FIG. 5C).

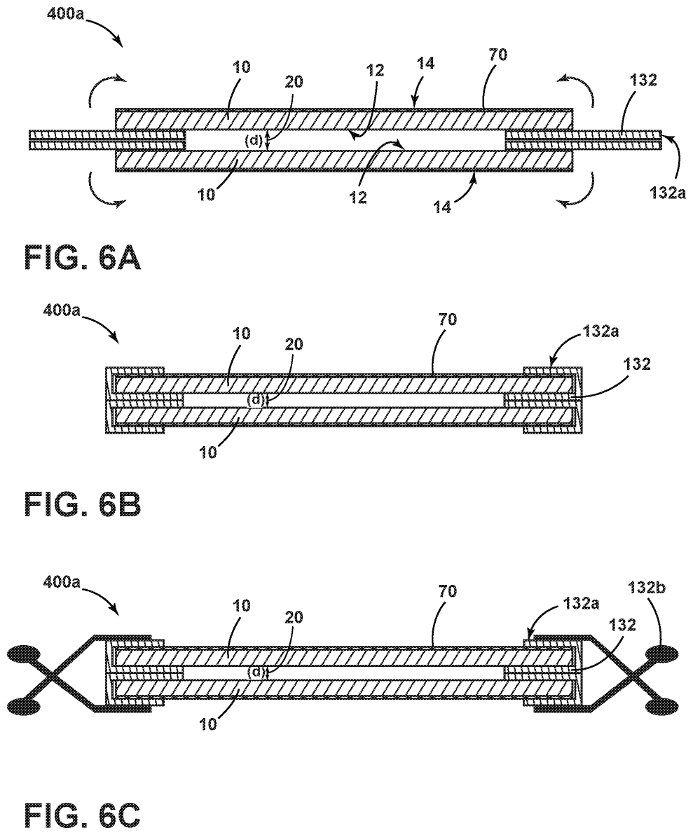

Referring now to FIGS. 6A-6D, a series of cross-sectional, schematic views depicts a method 400a for preparing a plurality of substrates 10 with a predetermined gap (d) 20 (FIG. 6C) set by virtue of an arrangement of spacer sheets 132 between their first primary surfaces 12. As shown in FIG. 6A, a pair of spacer sheets 132 with ends 132a is arranged between the first primary surfaces 12 of the substrates 10. As shown in FIGS. 6A and 6B, the ends 132a of the clips 132 are bent around edges of the substrates 10 (i.e., in the direction shown by the curved arrows) and into contact with the second primary surfaces 14 and secondary film 70 (e.g., an anti-glare surface). Now referring to FIG. 6C, clips 132b are secured over the ends 132a of the clips 132, to ensure that the pair of substrates 10 remains set apart by the predetermined gap (d) 20 formed by the spacer sheets 132. As such, the method 400a can be employed to fashion the spacer sheets 132 (and clips 132b) around the substrates 10 to result in a predetermined gap 20 between the first primary surfaces 12, which can be employed as part of the methods of making strengthened articles 100, 100a and 100b depicted in FIGS. 1-1C, 2-2C and 3-3C and described earlier.

Referring again to FIGS. 6A-6C, the spacer sheets 132 and clips 132b can be fabricated with a width that is shorter than the width of the substrates 10 (not shown), which maximizes the exposure of the primary surfaces 12, 14 of the substrates 10 to the ion-exchange bath 200 employed by the methods of making strengthened articles 100, 100a and 100b (see FIGS. 1-3C). Further, the spacer sheets 132 and clips 132b can be fabricated from any of a variety of materials that are non-reactive with regard to the ion-exchange bath 200 and the substrates 10 themselves, while having a level of ductility sufficient to afford the bending depicted in exemplary form in FIGS. 6A-6C. Suitable materials for the spacer sheets 132 and clips 132b include 300 series stainless steel, nickel alloys, aluminum alloys, aluminum metal, platinum, platinum alloys, In800 alloys, Cr—Mo alloys and other alloys as understood by those with ordinary skill in the field of the disclosure. Further, the spacer sheets 132 and clips 132b can also take on any of a variety of shapes and structures including but not limited to wires, cylindrical-shaped washers, cubic-shaped washers, rectangular-shaped washers, sheets, shims, clips, braces, supports, etc. In addition, the particular arrangement of the spacer sheets 132 and clips 132b outlined in FIGS. 6A-6C is exemplary; consequently, those with ordinary skill in the field of the disclosure can readily apply the principles set forth in this embodiment with a different sequence of bending and/or arrangement around the substrates 10 to accomplish the same function, i.e., the development of a predetermined gap (d) 20 between the first primary surfaces 12 of the substrates 10.

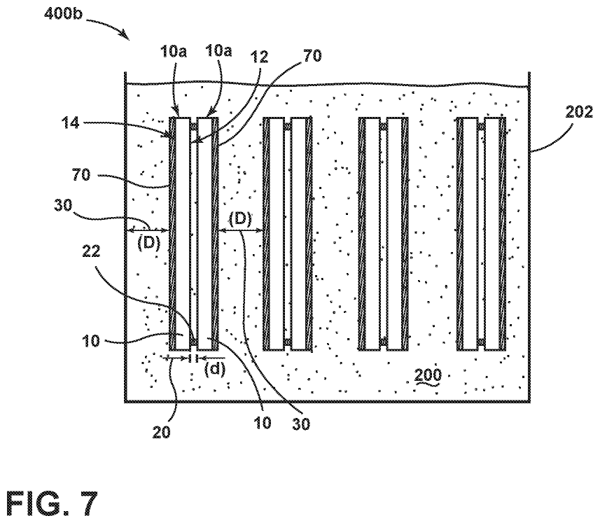

Referring now to FIG. 7, a cross-sectional, schematic view is provided that depicts an exemplary configuration for establishing a predetermined gap (d) 20 between substrates 10a, according to a method of making a strengthened article 400b. More particularly, the embodiments of the method 400b set forth in FIG. 7 is exemplary of approaches for scaling up the methods 100, 100a, 100b depicted in FIGS. 1-3C to produce larger quantities of strengthened articles consistent with the principles of the disclosure. According to the method 400b depicted in exemplary form in FIG. 7, pairs of substrates 10a, each having a secondary film 70 (e.g., an anti-glare surface) on their second primary surface 14, are arranged in a vessel 202 containing an ion-exchange bath 200 in a configuration to develop a predetermined gap (d) 20 between the first primary surfaces 12 of these substrates. As shown in FIG. 7, the pairs of substrates 10a are arranged vertically in the vessel 202 within the bath 200 and the predetermined gap (d) 20 is located in the horizontal direction between each of the pairs of substrates 10a and, further, the pairs of substrates are separated by a spacing (D) 30. In this configuration, the predetermined gap (d) 20 and spacing (D) 30 can be developed through any of the approaches outlined earlier, e.g., with spacers, wires, shims, sheets, a mesh, clips, etc. (e.g., with the spacers 22 shown in FIG. 7).

Referring again to FIG. 7, the individual substrates 10a are arranged vertically in the vessel 202 within the bath 200 and the predetermined gap 20 (d) is located in the horizontal direction between the first primary surfaces 12 of each of the substrates 10a, as set according to spacers 22 present between the substrates 10a (e.g., spacers fabricated from a series 300 stainless steel alloy). Further, a spacing (D) 30 separates the second primary surfaces 14 of each of the substrates 10a, or the wall of the vessel 202, as shown. The spacing (D) 30 can be set by spacers, wires, solid sheets, mesh sheets, washers, clips, brackets, slots within cartridges or other similar approaches (not shown), as understood by those of ordinary skill in the field of the disclosure.

According to an additional implementation of the method of making the strengthened articles 400b depicted in FIG. 7 (e.g., a method of manufacturing the strengthened articles depicted in FIGS. 1-3C), the predetermined gap (d) 20 can be configured to be smaller than the spacing (D) 30 from the second primary surface 14 of each of the substrates 10a to another substrate (e.g., to a second primary surface 14 of another substrate 10a) or a wall of a vessel 202 holding the bath 200. According to a further implementation of the method 400b, the predetermined gap (d) 20 is 1% of or less, 5% of or less, 10% of or less, 20% of or less, 25% of or less, 50% of or less, 75% of or less, 100% of or less, 150% of or less, 200% of or less, than a spacing (D) from the second primary surface 14 of each of the substrates 10a to another substrate (e.g., a substrate 10a) or a wall of a vessel 202 holding the bath 200. According to another implementation of the method 400b, the spacing (D) 30 from the second primary surface 14 of each of the substrates 10a to a second primary surface 14 of another substrate 10a or a wall of a vessel 202 is at least 5 mm, at least 7.5 mm, at least 10.0 mm, at least 12.5 mm, at least 15 mm, and the spacing (D) 30 levels between or exceeding these values. According to another implementation of the method 400b, the ratio of the predetermined gap (d) 20 to the spacing (D) 30 can be set such that d/D≤0.1, d/D≤0.05, or even d/D≤0.01.

### EXAMPLES

The following examples describe various features and advantages provided by the disclosure, and are in no way intended to limit the invention and appended claims.

### Example 1

In this example, Corning® Gorilla® Glass 3 substrate samples were prepared and subjected to a method of making strengthened articles according to principles and concepts of the disclosure (e.g., the method of making strengthened articles 100a depicted in FIGS. 2A and 2C). In particular, the substrates were sectioned into samples having dimensions of 166 mm×124 mm×1.05 mm and processed with an anti-glare (AG) layer on one of their two primary surfaces. The AG layer was formed through an etching process according to process suitable for the particular composition. Each of these samples was subjected to ion-exchange conditions in which the samples were immersed in a bath of 100% KNO₃ at 420° C. for 6 hours. Under these ion-exchange conditions in a conventional arrangement, i.e., without controlling the gap between the substrates, the substrates experienced significant warpage and bending toward their primary surfaces with the AG layer (i.e., the “control” samples in Table 1 below). According to the example, however, pairs of the samples were immersed such that the non-AG primary surfaces were back-to-back, as separated by a set of spacers positioned to create a predetermined gap (e.g., a predetermined gap (d) 20 resulting from a plurality of spacers 22, as shown in FIG. 2A). In this example, experiments were conducted on pairs of samples, as positioned with a predetermined gap formed by a plurality of spacers having a thickness (i.e., its long dimensions that spaces apart the substrates) of 0.4 mm, 1 mm, 1.4 mm and 2 mm.

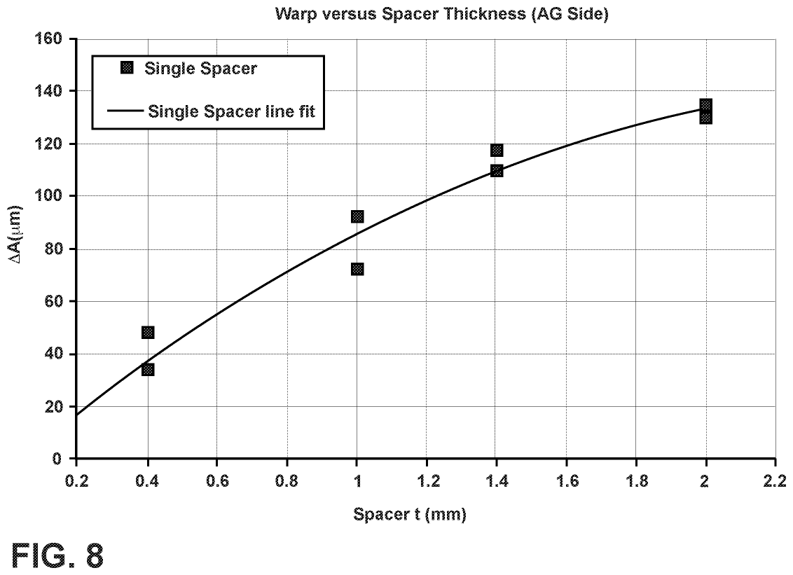

Also, each of the four sets of samples having a predetermined gap (e.g., a predetermined gap (d) 20) based on the four sets of spacer sizes, were subjected to warp and compressive stress region characterization. In particular, CS and DOL measurements were conducted on each of the primary surfaces of the samples using a surface stress meter (an FSM) after completion of the ion-exchange process steps. The warp measurements were made using a deflectometer (ISRA Vision 650×1300 mm system) on both sides of each sample, before and after being subjected to the ion-exchange process steps. The warp, CS and DOL measurements for the samples are reported below in Table 1 (i.e., as identified by spacer size—0.4 mm, 1 mm, 1.4 mm and 2 mm). Further, FIG. 8 depicts the warp evolution of the samples as a function of gap width/spacer size.

As is evident from Table 1 and FIG. 8, the thinnest spacer (0.4 mm) samples, as compared to the control samples, effectively reduced the CS difference on both primary surfaces from ˜23 MPa to <5 MPa while maintaining comparable DOL levels. Further, the warp evolution as a function of gap width (i.e., spacer thickness) from FIG. 8 clearly shows that the AG-induced warp increases with the thickness of the spacer, indicating a strong correlation between the warp and the gap size. The smallest warp (<40 μm) was obtained from the samples with the smallest spacer thickness, 0.4 mm. Further, the warp observed on the control samples ion-exchanged according to a conventional method without spacers can be said to be bowl-shaped, with bending toward the AG side, or dome-shaped, with bending toward the non-AG side. Nevertheless, these ‘bowl’ or ‘dome’ shapes were not observed in each of the sets of samples subjected to the ion-exchange conditions according to the principles of the disclosure with spacers having a size of 0.4 mm.

TABLE 1

| | | | | | | | Pre-IOX | Post-IOX | Δ Warp (Post − |
|---|---|---|---|---|---|---|---|---|---|
| | | | | | FSM | | Warp | Warp | Pre-IOX) |
| Spacer | | ID# | ΔW/W(%) | Side | CS(MPa) | DOL(μm) | Amplit. | Amplit. | Δ Amplit. |
| 0.4 | mm | 166-8 | 0.1965 | AG | 848 | 42.9 | 0.0434 | 0.0780 | 0.0345 |
| | | | | No-AG | 859 | 43.1 | 0.0264 | 0.0741 | 0.0477 |
| | | 166-9 | 0.1941 | No-AG | 850 | 43.1 | 0.0365 | 0.0445 | 0.0080 |
| | | | | AG | 851 | 42.9 | 0.0472 | 0.0909 | 0.0482 |
| 0.4 | mm | 166-11 | 0.1728 | AG | 843 | 42.8 | 0.0587 | 0.0925 | 0.0339 |
| | | | | No-AG | 840 | 43.2 | 0.0423 | 0.0664 | 0.0240 |
| | | 166-12 | 0.1952 | No-AG | 837 | 43.3 | 0.0854 | 0.0926 | 0.0072 |
| | | | | AG | 844 | 42.9 | 0.1227 | 0.1562 | 0.0335 |
| 1 | mm | 166-3 | 0.2148 | AG | 857 | 43.2 | 0.1250 | 0.1970 | 0.0720 |
| | | | | No-AG | 847 | 43.1 | 0.1119 | 0.1065 | −0.0054 |
| | | 166-4 | 0.1951 | No-AG | 848 | 43.2 | 0.1030 | 0.1121 | 0.0090 |
| | | | | AG | 859 | 43.2 | 0.1152 | 0.2081 | 0.0929 |
| 1.4 | mm | 166-1 | 0.1941 | AG | 865 | 42.9 | 0.0664 | 0.1760 | 0.1096 |
| | | | | No-AG | 843 | 43.3 | 0.0475 | 0.1387 | 0.0912 |
| | | 166-2 | 0.2226 | No-AG | 851 | 43.1 | 0.0481 | 0.1376 | 0.0896 |
| | | | | AG | 862 | 42.9 | 0.0659 | 0.1834 | 0.1175 |
| 2 | mm | 166-5 | 0.2138 | AG | 862 | 43.1 | 0.0671 | 0.1972 | 0.1301 |
| | | | | No-AG | 853 | 43.2 | 0.0340 | 0.1306 | 0.0965 |
| | | 166-6 | 0.2140 | No-AG | 850 | 43.1 | 0.0267 | 0.1128 | 0.0861 |
| | | | | AG | 862 | 42.9 | 0.0472 | 0.1817 | 0.1345 |

| | | | | | | | | |
|---|---|---|---|---|---|---|---|---|
| control | 166-7 | 0.2348 | AG | 873 | 42.8 | 0.1406 | 0.2573 | 0.1168 |
| | | | No-AG | 850 | 43.3 | 0.1290 | 0.1670 | 0.0407 |

### Example 2

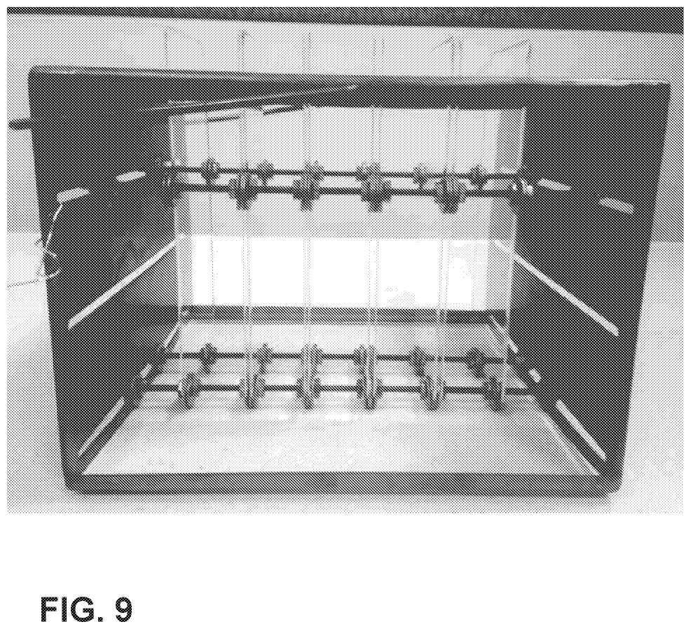

In this example, glass substrate (Corning® Gorilla® Glass 3) samples were prepared and subjected to a method of making strengthened articles according to principles and concepts of the disclosure (e.g., the method of making strengthened articles 100b depicted in FIGS. 3A-3C). In particular, the substrates were sectioned into samples having dimensions of 75 mm×150 mm×0.8 mm with beveled edges (vertical height=0.400 mm, horizontal distance=2.500 mm, and length=2.532 mm) on one primary surface and non-beveled edges on the opposing primary surface. Each of these samples was subjected to ion-exchange conditions in which the samples were immersed in a bath of 51 mol % KNO₃ at 460° C. for 14 hours. Under these ion-exchange conditions in a conventional arrangement, i.e., without controlling the gap between the substrates, the substrates experienced significant warpage and bending toward their primary surfaces with the beveled edges (i.e., asymmetric features) (i.e., the “control” samples in Table 2 below). According to the example, however, pairs of the samples were immersed such that the non-beveled surfaces were back-to-back, as separated by a set of spacers positioned to create a predetermined gap (e.g., a predetermined gap 20 resulting from a plurality of spacers 22 or mesh 24, as shown in FIGS. 3A and 3B). In this example, experiments were conducted on pairs of samples, as positioned with a predetermined gap formed by a plurality of spacers having a thickness (i.e., its long dimensions that spaces apart the substrates) of 0.06 mm spacers, 0.24 mm spacers, and a 0.66 mm mesh screen, as shown in the photograph of FIG. 9.

Also as part of this example, each of the three sets of samples having a predetermined gap based on the three spacer/mesh sizes, were subjected to warp and compressive stress region characterization. In particular, CS and DOL measurements were conducted on each of the primary surfaces of the samples using a surface stress meter (an FSM) after completion of the ion-exchange process steps. The warp measurements were made using a conventional deflectometer as employed by those with ordinary skill in the field of the disclosure on both sides of each sample, before and after being subjected to the ion-exchange process steps. The warp, CS and DOL measurements for the samples are reported below in Table 2 (i.e., as identified by spacer/mesh size-control (no spacer/mesh), 0.06 mm, 0.24 mm and 0.66 mm).

As is evident from the results in Table 2, the warp observed in the control samples, 0.66 mesh screen samples, and 0.24 washer samples was in one direction (i.e., it was non-negative) and, more particularly, cylindrical- or dome-shaped. The warp observed in the other samples fabricated with 0.06 mm washers was in the other direction (i.e., it was negative) and, more particularly, bowl-shaped with a smaller magnitude than observed in the other samples. Further, it appears from the data that the degree of warp observed is reduced for the 0.24 mm washer samples as compared to the control. The data in Table 2 also demonstrates that the magnitude of the warp shifts in direction for the 0.06 mm washer samples; consequently, it is believed that the optimal condition for eliminating or minimizing the magnitude of warp involves using washers that fall between 0.24 mm and 0.06 mm in size. Finally, the compressive stress region data in Table 2 demonstrates that there are no significant differences observed in CS and DOL for the samples fabricated with a predetermined gap and the control samples that lack a controlled spacing.

TABLE 2

| | | | CS, | CS, non- | DOL, | DOL, non- |
|---|---|---|---|---|---|---|
| | | | beveled | beveled | beveled | beveled |
| Sample | | Warp | side | side | side | side |
| ID | Condition | (μm) | (MPa) | (MPa) | (μm) | (μm) |
| T1 | Control | 121 | 229 | 233 | 147 | 151 |
| T2 | | | 235 | 239 | 154 | 148 |
| T3 | 0.66 mm | 109 | 233 | 230 | 149 | 148 |
| T4 | mesh | | 230 | 230 | 148 | 146 |
| T9 | screen | | 232 | 234 | 149 | 141 |
| T10 | | | 229 | 231 | 151 | 148 |
| T7 | 0.24 mm | 111 | 235 | 230 | 154 | 149 |
| T8 | washer | | 232 | 230 | 149 | 150 |
| T13 | | | 233 | 232 | 151 | 153 |
| T14 | | | 235 | 229 | 152 | 148 |
| T5 | 0.06 mm | −77 | 233 | 228 | 148 | 150 |
| T6 | washer | | 232 | 224 | 143 | 151 |
| T7 | | | 231 | 225 | 148 | 147 |
| T8 | | | 229 | 225 | 147 | 149 |

### Example 3

In this example, glass substrate (Corning® Gorilla® Glass 3) samples were prepared and subjected to a method of making strengthened articles according to principles and concepts of the disclosure (e.g., the method of making strengthened articles 100b depicted in FIGS. 3A and 3C). In particular, the substrates were sectioned into a 2.5 D sample geometry with a thickness of 0.8 mm with beveled edges (vertical height=0.400 mm, horizontal distance=2.500 mm, and length=2.532 mm) on one primary surface and non-beveled edges on the opposing primary surface. Each of these samples was subjected to ion-exchange conditions in which the samples were immersed in a bath of 49% NaNO₃ and 51% KNO₃ at 460° C. for 14 hours. Under these ion-exchange conditions in a conventional arrangement, i.e., without controlling the gap between the substrates, the substrates experienced significant warpage and bending toward their primary surfaces with the beveled edges (i.e., asymmetric features) (i.e., the “control” samples in Table 3 below). According to the example, however, pairs of the samples were immersed such that the non-beveled surfaces were back-to-back, as separated by a set of spacers positioned to create a predetermined gap (e.g., a predetermined gap 20 resulting from a plurality of spacers 22, as shown in FIG. 3A). In this example, experiments were conducted on pairs of samples, as positioned with a predetermined gap formed by a plurality of spacers having a thickness (i.e., its long dimensions are what spaces apart the substrates) of 0.05 mm spacers, 0.12 mm spacers, and 0.21 mm spacers.

Also as part of this example, each of the three sets of samples having a predetermined gap based on the three spacer sizes, were subjected to warp and compressive stress region characterization. In particular, CS and DOL measurements were conducted on each of the primary surfaces of the samples using a surface stress meter (an FSM) after completion of the ion-exchange process steps. The warp measurements were made using a conventional deflectometer as employed by those with ordinary skill in the field of the disclosure on both sides of each sample, before and after being subjected to the ion-exchange process steps. The warp, CS and DOL measurements for the samples are reported below in Table 3 and FIGS. 8A and 8B (i.e., as identified by spacer size-control (no spacer), 0.05 mm, 0.12 mm and 0.21 mm).

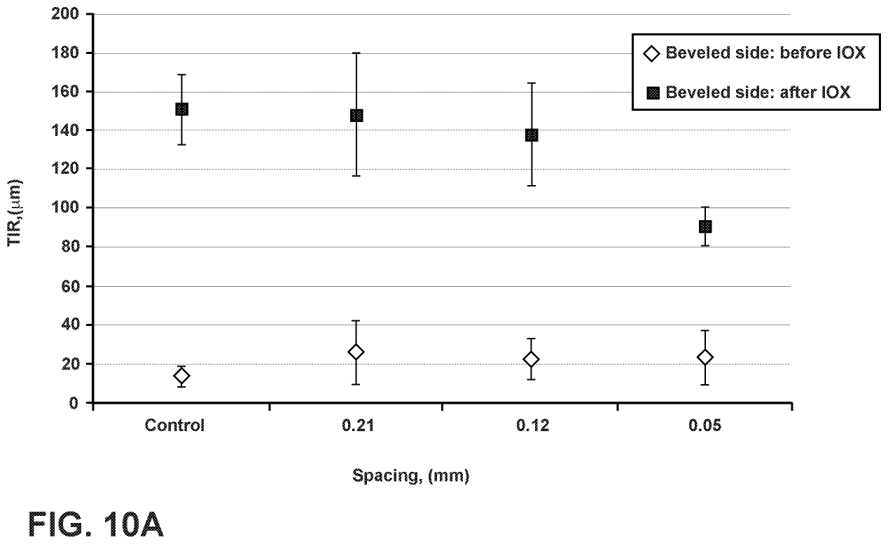

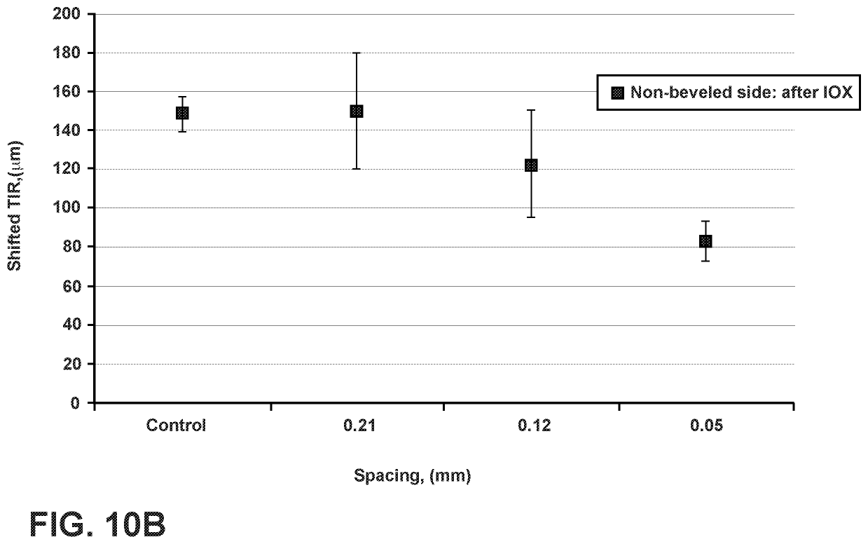

As is evident from the results in Table 3 and FIGS. 10A and 10B, the warp observed on the beveled primary surface of the control samples (warp ˜137 μm) is significantly higher than the levels of warp observed for the samples fabricated with a predetermined gap through spacers of various sizes, 0.21 mm (warp ˜123 μm), 0.12 mm (warp ˜116 μm) and 0.05 mm (warp ˜67 μm). A similar trend is also evident in the non-beveled side (see FIG. 10B). Accordingly, this example demonstrates that increasingly smaller spacer sizes can result in less warp observed in the samples. Without being bound by theory, it is also believed that decreasing the size of the spacers can further improve observed warp levels, provided that the spacing is not so small as to become dominated by capillary and/or surface-energy driven effects. As surface energy and capillary effects begin to dominate, the movement of the molten salt in the ion-exchange bath to facilitate exchange of the ion-exchanging ions with ion-exchangeable ions in the substrates is reduced.

TABLE 3

| Spacer thickness, | Av TIR (μm) | | Shifted TIR (μm) | |
|---|---|---|---|---|
| mm | Before IOX | After IOX | Avg. | Stdev |
| Control, 0 mm | 13.56 | 150.83 | 137.27 | 8.94 |
| 0.21 mm spacer | 25.78 | 148.34 | 122.56 | 29.66 |
| 0.12 mm spacer | 22.21 | 138.07 | 115.86 | 27.62 |
| 0.05 mm spacer | 23.44 | 90.80 | 67.36 | 10.21 |

### Example 4

In this example, Corning® Gorilla® Glass 3 substrate samples were prepared and subjected to a method of making strengthened articles according to principles and concepts of the disclosure (e.g., the method of making strengthened articles 100a depicted in FIGS. 2A and 2C). In particular, the substrates were sectioned into samples having dimensions of 490 mm×310 mm×1.05 mm and processed with an anti-glare (AG) surface on one of their two primary surfaces. The AG surface treatment was performed according to an etching process suitable for the particular composition. Next, all of the samples were loaded into a cassette with pairs of samples arranged according to various predetermined gap levels and subjected to ion-exchange conditions in which the samples were immersed in a bath of 100% KNO₃ at 420° C. for 6 hours.

As detailed below in Table 4, a first group of samples served as a control, with pairs of substrates loaded into the cassette without spacers such that a predetermined gap (d) of at least 10 mm was present between each substrate and a spacing (D) of at least 10 mm between each pair of substrates (denoted as “Control (no spacer)”). A second group of samples was loaded in the cassette such that pairs of substrates were arranged with a predetermined gap (d) determined by 0.4 mm thick stainless steel spacers and a spacing (D) of at least 10 mm (denoted as “0.4 mm SS spacer”). A third group of samples was loaded in the cassette such that pairs of substrates were arranged with a predetermined gap (d) determined by 0.3 mm thick platinum spacers and a spacing (D) of at least 10 mm (denoted as “0.3 mm Pt spacer”). A fourth group of samples was loaded in the cassette such that pairs of substrates were arranged with a predetermined gap (d) determined by 0.3 mm thick aluminum alloy spacers and a spacing (D) of at least 10 mm (denoted as “0.3 mm Al spacer”). A fifth group of samples was loaded in the cassette such that pairs of substrates were arranged with a predetermined gap (d) determined by 0.6 mm thick aluminum alloy spacers and a spacing (D) of at least 10 mm (denoted as “0.6 mm Al spacer”).

Also as part of this example, each of the five sets of samples having a predetermined gap based on the five sets of spacer sizes (i.e., as inclusive of the group having no spacers) were subjected to warp characterization. In particular, the warp measurements were made using a deflectometer (ISRA Vision 650×1300 mm system) on both sides of each sample, before and after being subjected to the ion-exchange process steps. The warp measurements for the samples are reported below in Table 4 (i.e., as identified by spacer size, as noted above). As is evident from Table 4, under these ion-exchange conditions in a conventional arrangement, i.e., without controlling the gap between the substrates, the substrates experienced significant warpage and bending toward their primary surfaces having the AG surface (i.e., the “Control (no spacer)” samples). Notably, the AG surface of the control group exhibited a warp increase (Δ warp) of about 0.90 mm. In contrast, the substrates of the sample groups arranged in the cassette with a predetermined gap set by spacers ranging in thickness from 0.3 mm to 0.6 mm experienced significantly less change in warpage (i.e., the “0.4 mm SS spacer”, “0.3 mm Pt spacer”, “0.3 mm Al spacer” and “0.6 mm Al spacer” groups. In particular, the samples of the groups arranged with spacers exhibited a warp increase (Δ warp) that ranged from 0.12 mm (“0.4 mm SS spacer”); −0.03 mm and −0.09 mm (“0.3 mm Pt spacer”); 0.09 mm and −0.08 mm (“0.3 mm Al spacer”); and 0.13 mm and 0.09 mm (“0.6 mm Al spacer”).

TABLE 4

| | | | Pre-IOX | Post-IOX | Δ Warp (Post − |
|---|---|---|---|---|---|
| | | | Warp | Warp | Pre-IOX) |
| Spacer | ID# | Side | Amplit. | Amplit. | Δ Amplit. |
| 0.4 | 7K14-1 | AG | 0.19922 | 0.31487 | 0.11565 |
| mm SS | 7L1-1 | No-AG | 0.08271 | 0.14896 | 0.06625 |
| spacer | 7K14-2 | No-AG | 0.07780 | 1.12394 | 1.04614 |
| | 7L1-2 | AG | 0.22795 | 0.60940 | 0.38145 |
| 0.3 | 7K14-3 | AG | 0.23270 | 0.20579 | −0.02692 |
| mm Pt | 7L1-3 | No-AG | 0.16173 | 0.11333 | −0.04840 |
| spacer | 7K14-4 | No-AG | 0.12294 | 0.08301 | −0.03993 |
| | 7L1-4 | AG | 0.24230 | 0.15621 | −0.08609 |
| 0.3 | 7K14-5 | AG | 0.12485 | 0.21933 | 0.09448 |
| mm Al | 7L1-5 | No-AG | 0.19487 | 0.34076 | 0.14589 |
| spacer | 7K14-6 | No-AG | 0.13281 | 0.29358 | 0.16077 |
| | 7L1-6 | AG | 0.30915 | 0.22857 | −0.08058 |
| 0.6 | 7K14-7 | AG | 0.12436 | 0.25821 | 0.13384 |
| Al mm | 7L1-7 | No-AG | 0.12368 | 0.29196 | 0.16828 |
| spacer | 7K14-8 | No-AG | 0.18424 | 0.24732 | 0.06308 |
| | 7L1-8 | AG | 0.09825 | 0.18415 | 0.08590 |
| Control | 7K14-9 | AG | 0.00022 | 0.89922 | 0.89900 |
| (no spacer) | 7L1-9 | No-AG | 0.07170 | 0.10066 | 0.02896 |

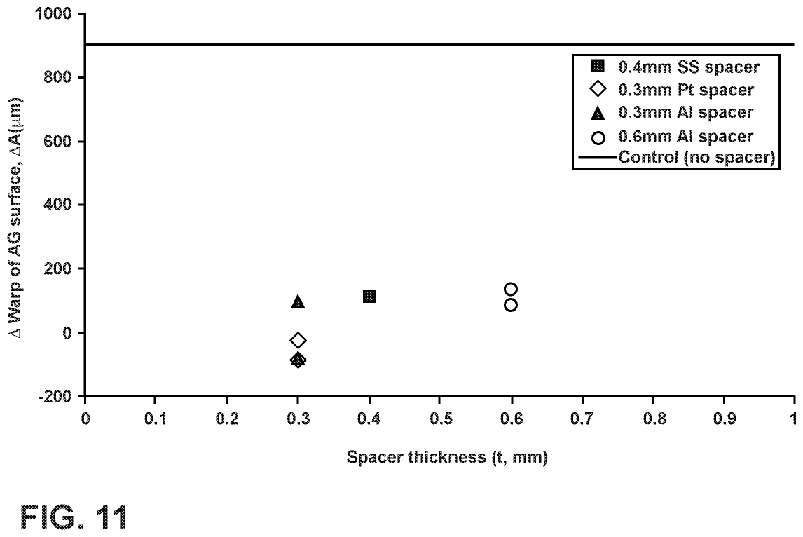

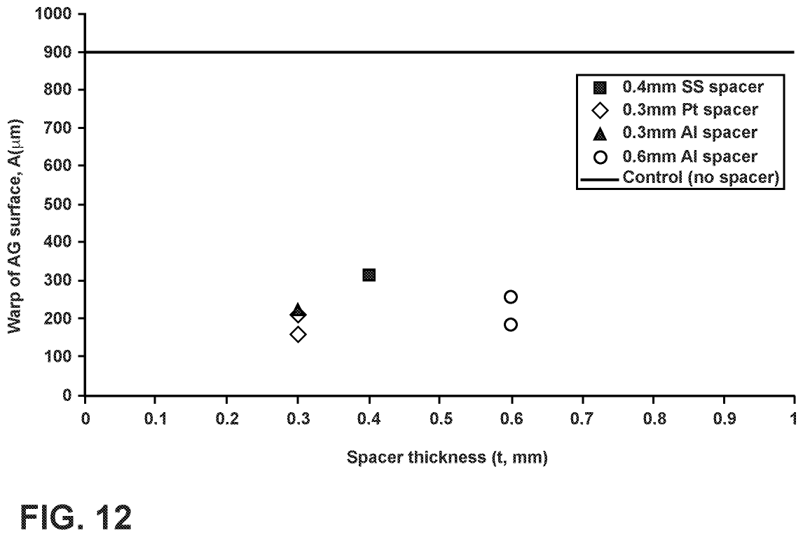

Referring now to FIGS. 11 and 12, plots of change in warp (Δ warp) and warp amplitude (A) as a function of spacer thickness, respectively, are provided for the samples listed in Table 4 above. As is clearly evident from these figures, the samples subjected to the ion-exchange conditions of this example with a predetermined gap (d) between 0.3 mm and 0.6 mm and a spacing (D) of at least 10 mm exhibited significantly lower warp amplitudes (A) and changes in warp (Δ warp) as compared to the control samples with no spacers, as having a predetermined gap (d) and spacing (D) of at least 10 mm.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

According to a first aspect of the disclosure, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, at least one of: (a) an exchange rate of the ion-exchanging alkali metal ions is higher into the first primary surface than into the second primary surface and (b) the second primary surface comprises one or more asymmetric features having a total surface area that exceeds a total surface area of any asymmetric features of the first primary surface. In addition, the submersing step is conducted such that a predetermined gap is maintained between the first primary surface of each of the articles.

According to a second aspect of the disclosure, the first aspect is provided, wherein the gap ranges from about 0.02 mm to about 2.5 mm, and further wherein the gap is smaller than a spacing from the second primary surface of each of the articles to another article or a wall of a vessel holding the bath.

According to a third aspect, the first aspect or the second aspect is provided, wherein the gap is set by a plurality of spacers, each spacer in contact with the first primary surface of the articles.

According to a fourth aspect, the first aspect or the second aspect is provided, wherein the gap is set by a mesh sheet, each mesh sheet in contact with the first primary surface of a pair of the articles.

According to a fifth aspect, any one of the first through the fourth aspects is provided, wherein each of the plurality of strengthened articles comprises a warp (Δ warp) of 150 microns or less.

According to a sixth aspect, any one of the first through the fourth aspects is provided, wherein each of the plurality of strengthened articles comprises a warp (Δ warp) of 50 microns or less.

According to a seventh aspect, any one of the first through the sixth aspects is provided, wherein each article comprises a glass composition selected from the group consisting of soda lime silicate, alkali aluminosilicate, borosilicate and phosphate glasses.

According to an eighth aspect, the aspect of any one of the first through the seventh aspects is provided, wherein each of the plurality of strengthened articles comprises a maximum warpage of less than 0.1% of the longest dimension of the article.

According to a ninth aspect, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, an exchange rate of the ion-exchanging alkali metal ions is higher into the first primary surface than into the second primary surface. In addition, the submersing step is conducted such that a predetermined gap is maintained between the first primary surface of each of the articles.

According to a tenth aspect, the ninth aspect is provided, wherein the second primary surface of each of the plurality of articles comprises at least one of an anti-glare layer disposed thereon, an anti-glare surface and an anti-reflective layer disposed thereon.

According to an eleventh aspect, the ninth aspect or the tenth aspect is provided, wherein the gap ranges from about 0.02 mm to about 2.5 mm, and further wherein the gap is smaller than a spacing from the second primary surface of each of the articles to another article or a wall of a vessel holding the bath.

According to a twelfth aspect, any one of the ninth through the eleventh aspects is provided, wherein the gap is set by a plurality of spacers, each spacer in contact with the first primary surface of the pair of the articles.

According to a thirteenth aspect, any one of the ninth through the eleventh aspects is provided, wherein the gap is set by a mesh sheet, each mesh sheet in contact with the first primary surface of a pair of the articles.

According to a fourteenth aspect, any one of the ninth through the thirteenth aspects is provided, wherein each of the plurality of strengthened articles comprises a warp (Δ warp) of 200 microns or less.

According to a fifteenth aspect, any one of the ninth through the thirteenth aspects is provided, wherein each of the plurality of strengthened articles comprises a warp (Δ warp) of 50 microns or less.

According to a sixteenth aspect, any one of the ninth through the fifteenth aspects is provided, wherein each article comprises a glass composition selected from the group consisting of soda lime silicate, alkali aluminosilicate, borosilicate and phosphate glasses.

According to a seventeenth aspect, the aspect of any one of the ninth through the sixteenth aspects is provided, wherein each of the plurality of strengthened articles comprises a maximum warpage of less than 0.1% of the longest dimension of the article.

According to an eighteenth aspect, the ninth aspect or the tenth aspect is provided, wherein the predetermined gap (d) ranges from about 0.02 mm to about 2.5 mm, wherein a spacing (D) is maintained from the second primary surface of each of the articles to another second primary surface of another article or a wall of a vessel holding the bath, and further wherein d/D≤0.1.

According to a nineteenth aspect, the ninth aspect or the tenth aspect is provided, wherein the predetermined gap (d) ranges from about 0.02 mm to about 2.5 mm, wherein a spacing (D) is maintained from the second primary surface of each of the articles to another second primary surface of another article or a wall of a vessel holding the bath, and further wherein D≥10 mm.

According to a twentieth aspect, a method of making strengthened articles is provided that includes: providing a plurality of articles, each article comprising a glass, glass-ceramic or ceramic composition with a plurality of ion-exchangeable alkali metal ions, a first primary surface and a second primary surface; providing a first ion-exchange bath comprising a plurality of ion-exchanging alkali metal ions, each having a larger size than the size of the ion-exchangeable alkali metal ions; and submersing the plurality of articles in the first ion-exchange bath at a first ion-exchange temperature and duration to form a plurality of strengthened articles. Each strengthened article comprises a compressive stress region extending from the first and second primary surfaces to respective first and second selected depths. Further, the second primary surface comprises one or more asymmetric features having a total surface area that exceeds a total surface area of any asymmetric features of the first primary surface. In addition, the submersing step is conducted such that a predetermined gap is maintained between the first primary surface of each of the articles.

According to a twenty-first aspect, the twentieth aspect is provided, wherein the first and second primary surface of each of the plurality of articles comprise one or more asymmetric features in the form of at least one of a beveled edge, a chamfered edge and a rounded edge.

According to a twenty-second aspect, the twentieth aspect or the twenty-first aspect is provided, wherein the gap ranges from about 0.02 mm to about 2.5 mm, and further wherein the gap is smaller than a spacing from the second primary surface of each of the articles to another article or a wall of a vessel holding the bath.

According to a twenty-third aspect, any one of the twentieth through the twenty-second aspects is provided, wherein the gap is set by a plurality of spacers, each spacer in contact with the first primary surface of the pair of the articles.

According to a twenty-fourth aspect, any one of the twentieth through the twenty-third aspects is provided, wherein the gap is set by a mesh sheet, each mesh sheet in contact with the first primary surface of a pair of the articles.

According to a twenty-fifth aspect, any one of the twentieth through the twenty-fourth aspects is provided, wherein each of the plurality of strengthened articles comprises a warp (Δ warp) of 150 microns or less.

According to a twenty-sixth aspect, any one of the twentieth through the twenty-fourth aspects is provided, wherein each of the plurality of strengthened articles comprises a warp (Δ warp) of 50 microns or less.

According to a twenty-seventh aspect, any one of the twentieth through the twenty-sixth aspects is provided, wherein each article comprises a glass composition selected from the group consisting of soda lime silicate, alkali aluminosilicate, borosilicate and phosphate glasses.

According to a twenty-eighth aspect, any one of the twentieth through the twenty-seventh aspects is provided, wherein each of the plurality of strengthened articles comprises a maximum warpage of less than 0.1% of the longest dimension of the article.

According to a twenty-ninth aspect, a strengthened article is provided that is made according to the method of any one of aspects one through twenty-eight.

According to a thirtieth aspect, a glass article is provided, comprising: a glass substrate that is chemically strengthened, the glass substrate comprising a first primary surface and a second primary surface, and compressive stress regions extending from the first and second primary surfaces to respective first and second selected depths, wherein the glass article comprises a warp (Δ warp) of 200 microns or less.

According to a thirty-first aspect, the glass article of aspect thirty is provided, wherein the glass article comprises a warp (Δ warp) of 50 microns or less.

According to a thirty-second aspect, the glass article of aspect thirty or thirty-one is provided, wherein the glass substrate comprises a glass composition selected from the group consisting of soda lime silicate, alkali aluminosilicate, borosilicate and phosphate glasses.

According to a thirty-third aspect, the glass article of any one of aspects thirty through thirty-two is provided, wherein the glass article comprises a maximum warpage of less than 0.1% of the longest dimension of the article.

According to a thirty-fourth aspect, the glass article of any one of aspects thirty through thirty-three is provided, wherein the compressive stress regions extending from the first and second primary surfaces are asymmetric.

According to a thirty-fifth aspect, the glass article of the thirty-fourth aspect is provided, wherein the compressive stress regions extending from the first and second primary surfaces comprises different amounts of ion-exchanged ions from a chemical strengthening process of the glass substrate.

According to a thirty-sixth aspect, the glass article of the thirty-fourth or thirty-fifth aspect is provided, wherein the second primary surface comprises one or more asymmetric features having a total surface area that exceeds a total surface area of any asymmetric features of the first primary surface.

According to a thirty-seventh aspect, the glass article of any one of the thirtieth through thirty-sixth aspects is provided, wherein the second primary surface of each of the glass articles comprises at least one of an anti-glare layer disposed thereon, an anti-glare surface, and an anti-reflective film disposed thereon.

According to a thirty-eighth aspect, the glass article of the thirty-seventh aspect is provided, wherein the anti-glare layer, anti-glare surface or the anti-reflective film was formed on the glass substrate prior to chemical strengthening.

According to a thirty-ninth aspect, the glass article of any one of the thirtieth through thirty-eighth aspects is provided, wherein the first and second primary surfaces of the glass article comprise one or more asymmetric features in the form of at least one of a beveled edge, a chamfered edge and a rounded edge.

1. A method of making strengthened articles, comprising:
providing a plurality of articles, each article comprising a glass, glass-ceramic or ceramic composition with a plurality of ion-exchangeable alkali metal ions, a first primary surface and a second primary surface;
providing a first ion-exchange bath comprising a plurality of ion-exchanging alkali metal ions, each having a larger size than the size of the ion-exchangeable alkali metal ions; and
submersing the plurality of articles in the first ion-exchange bath at a first ion-exchange temperature and duration to form a plurality of strengthened articles, each strengthened article comprising a compressive stress region extending from the first and second primary surfaces to respective first and second selected depths,
wherein at least one of: (a) an exchange rate of the ion-exchanging alkali metal ions is higher into the first primary surface than into the second primary surface and (b) the second primary surface comprises one or more asymmetric features having a total surface area that exceeds a total surface area of any asymmetric features of the first primary surface, and
further wherein the submersing step is conducted such that a predetermined gap is maintained between the first primary surface of each of the articles.

2. The method according to claim 1, wherein the gap ranges from about 0.02 mm to about 2.5 mm, and further wherein the gap is smaller than a spacing from the second primary surface of each of the articles to another article or a wall of a vessel holding the bath.

3. The method according to claim 1, wherein the gap is set by a plurality of spacers, each spacer in contact with the first primary surface of a pair of the articles.

4. The method according to claim 1, wherein the gap is set by a mesh sheet, each mesh sheet in contact with the first primary surface of a pair of the articles.

5. The method according to claim 1, wherein each of the plurality of strengthened articles comprises a warp (Δ warp) of 150 microns or less.

6. The method according to claim 1, wherein each of the plurality of strengthened articles comprises a warp (Δ warp) of 50 microns or less.

7. The method according to claim 1, wherein each article comprises a glass composition selected from the group consisting of soda lime silicate, alkali aluminosilicate, borosilicate and phosphate glasses.

8. The method according to claim 1, wherein each of the plurality of strengthened articles comprises a maximum warpage of less than 0.1% of the longest dimension of the article.

9.-28. (canceled)

29. A strengthened article made according to the method of claim 1.

30. A glass article, comprising:
a glass substrate that is chemically strengthened, the glass substrate comprising a first primary surface and a second primary surface, and compressive stress regions extending from the first and second primary surfaces to respective first and second selected depths,
wherein the glass article comprises a warp (Δ warp) of 200 microns or less.

31. The glass article of claim 30, wherein the glass article comprises a warp (A warp) of 50 microns or less.

32. The glass article of claim 30, wherein the glass substrate comprises a glass composition selected from the group consisting of soda lime silicate, alkali aluminosilicate, borosilicate and phosphate glasses.

33. The glass article of claim 30, wherein the glass article comprises a maximum warpage of less than 0.1% of the longest dimension of the article.

34. The glass article of claim 30, wherein the compressive stress regions extending from the first and second primary surfaces are asymmetric.

35. The glass article of claim 34, wherein the compressive stress regions extending from the first and second primary surfaces comprises different amounts of ion-exchanged ions from a chemical strengthening process of the glass substrate.

36. The glass article of claim 34, wherein the second primary surface comprises one or more asymmetric features having a total surface area that exceeds a total surface area of any asymmetric features of the first primary surface.

37. The glass article of claim 30, wherein the second primary surface of each of the glass articles comprises at least one of an anti-glare layer disposed thereon, an anti-glare surface, and an anti-reflective film disposed thereon.

38. The glass article of claim 37, wherein the anti-glare layer, anti-glare surface or the anti-reflective film was formed on the glass substrate prior to chemical strengthening.

39. The glass article of claim 30, wherein the first and second primary surfaces of the glass article comprise one or more asymmetric features in the form of at least one of a beveled edge, a chamfered edge and a rounded edge.

40. The glass article of claim 37, wherein the anti-glare layer or anti-glare surface formed on the glass substrate prior to chemical strengthening.
